(19) United States
(12) Patent Application Publication
(10) Pub. No.: US 2025/0271609 A1
(43) Pub. Date: Aug. 28, 2025

(54) DISPLAY DEVICE

(71) Applicant: LG Display Co., Ltd., Seoul (KR)

(72) Inventors: Youngmin KWON, Daegu (KR); HyukKyu KWON, Daegu (KR)

(73) Assignee: LG Display Co., Ltd., Seoul (KR)

(21) Appl. No.: 19/060,414

(22) Filed: Feb. 21, 2025

(30) Foreign Application Priority Data
Feb. 22, 2024 (KR) 10-2024-0025947

(51) Int. Cl. F21V 8/00

(52) U.S. Cl. CPC G02B 6/005

(57) ABSTRACT

A display device can include a first light source unit having a plurality of first light sources, a first light controller disposed on the first light source unit and having a plurality of partitions overlapping at least a partial area of the active area, a second light controller disposed on the first light controller and having a plurality of light control patterns overlapping at least a partial area of the active area, a second light source unit disposed on the second light controller and having plurality of second light sources, a light guide plate disposed to be parallel to the second light source unit and configured to guide light provided from the second light source unit, and a display panel disposed on the light guide plate and configured to display an image using light provided from the first light source unit or the second light source unit.

### CROSS-REFERENCE TO RELATED APPLICATIONS

This application claims priority to Korean Patent Application No. 10-2024-0025947 filed on Feb. 22, 2024, in the Korean Intellectual Property Office, the entire disclosure of which are hereby expressly incorporated by reference into the present application.

### BACKGROUND

### Technical Field

The present disclosure relates to a display device, and more particularly to a display device in which a viewing angle is controllable.

### Description of the Related Art

As the technology in modern society develops, display devices are used in various ways to provide information to users. The display devices include not only electronic signs which simply transmit visual information in one direction, but also various electronic devices which need higher level of technology to check a user's input and provide information in response to the checked input.

For example, a display device is included in a vehicle to provide various information to a driver and passengers of the vehicle. However, the display device of the vehicle needs to appropriately display contents without interrupting the operation of the vehicle. For example, the display device needs to limit or control the display of the contents which can reduce the user's concentration on driving while the vehicle is in operation.

The description provided in the discussion of the related art section should not be assumed to be prior art merely because it is mentioned in or associated with that section. The discussion of the related art section can include information that describes one or more aspects of the subject technology, and the description in this section does not limit the present disclosure.

### SUMMARY OF THE DISCLOSURE

A benefit to be achieved by the present disclosure is to provide a display device which provides contents in a first area of an active area at a wide viewing angle and provides contents in a second area at a wide viewing angle or a narrow viewing angle according to a driving mode.

Another benefit to be achieved by the present disclosure is to provide a display device which reduces or minimizes a boundary visibility between a first area and a second area of a display panel.

Benefits of the present disclosure are not limited to the above-mentioned benefits, and other benefits, which are not mentioned above, can be clearly understood by those skilled in the art from the following descriptions.

A display device according to an example embodiment of the present disclosure includes a first light source unit including a plurality of first light sources, a first light controller which is disposed on the first light source unit and includes a plurality of partitions overlapping at least a partial area of the active area, a second light controller which is disposed on the first light controller and includes a plurality of light control patterns overlapping at least a partial area of the active area, a second light source unit which is disposed on the second light controller and includes a plurality of second light sources, a light guide plate which is disposed to be parallel to the second light source unit and guides light provided from the second light source unit, and a display panel which is disposed on the light guide plate and displays an image using light provided from the first light source unit or the second light source unit.

Other detailed matters of the example embodiments are included in the detailed description and the drawings.

According to aspects of the present disclosure, some light source units disposed below a display panel are controlled to emit light according to a driving mode to control both a first area and a second area as a wide field-of-view mode in a first mode and control a first area as a wide field-of-view mode and a second area as a narrow field-of-view mode in a second mode.

According to aspects of the present disclosure, a light control pattern which scatters and/or irregularly reflects incident light is disposed in a third area including a boundary line between a first area and a second area so that a boundary visibility between the first area and the second area can be reduced or minimized.

The effects according to the present disclosure are not limited to the contents exemplified above, and more various effects are included in the present disclosure.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing general description and the following detailed description are example and explanatory and are intended to provide further explanation of the inventive concepts as claimed.

### BRIEF DESCRIPTION OF THE DRAWINGS

The accompanying drawings, that can be included to provide a further understanding of the disclosure and can be incorporated in and constitute a part of the disclosure, illustrate embodiments of the disclosure and together with the description serve to explain various principles of the disclosure. The above and other aspects, features and other advantages of the present disclosure will be more clearly understood from the following detailed description taken in conjunction with the accompanying drawings, in which:

FIG. 1 is an example view of a display device according to an example embodiment of the present disclosure;

FIG. 2 is an exploded perspective view of a display device according to one or more example embodiments of the present disclosure;

FIG. 3 is a view illustrating an example of a display panel included in a display device according to an example embodiment of the present disclosure;

FIG. 4A is a side view schematically illustrating an example of a first light controller included in the display device of FIG. 2;

FIG. 4B is an enlarged view illustrating an example of a part EA1 of FIG. 4A;

FIG. 5A is a side view schematically illustrating another example of a first light controller included in the display device of FIG. 2;

FIG. 5B is an enlarged view illustrating an example of a part EA2 of FIG. 5A;

FIG. 6 is a side view schematically illustrating still another example of a first light controller included in the display device of FIG. 2;

FIG. 7 is a side view schematically illustrating still another example of a first light controller included in the display device of FIG. 2;

FIG. 8A is a side view schematically illustrating still another example of a first light controller included in the display device of FIG. 2;

FIG. 8B is an enlarged view illustrating an example of a part EA3 of FIG. 8A;

FIG. 9 is a side view schematically illustrating still another example of a first light controller included in the display device of FIG. 2;

FIG. 10A is a perspective view schematically illustrating still another example of a first light controller included in the display device of FIG. 2;

FIG. 10B is a plan view schematically illustrating still another example of a first light controller included in the display device of FIG. 2;

FIG. 11 is a plan view schematically illustrating an example of a second light controller included in the display device of FIG. 2;

FIGS. 12A and 12B are views for explaining an example of a traveling path of light in a display device according to an example embodiment of the present disclosure;

FIG. 13 is a plan view schematically illustrating another example of a second light controller included in the display device of FIG. 2;

FIG. 14 is a plan view schematically illustrating still another example of a second light controller included in the display device of FIG. 2;

FIG. 15 is a plan view schematically illustrating still another example of a second light controller included in the display device of FIG. 2;

FIG. 16 is a plan view schematically illustrating still another example of a second light controller included in the display device of FIG. 2;

FIG. 17 is an exploded perspective view of a display device according to another example embodiment(s) of the present disclosure;

FIG. 18 is a side view schematically illustrating an example of a light guide plate included in the display device of FIG. 17;

FIG. 19 is a bottom view schematically illustrating an example of a light guide plate included in the display device of FIG. 17;

FIG. 20 is a side view of a display device according to another example embodiment of the present disclosure; and

FIG. 21 is a rear-side view schematically illustrating another example of a light guide plate included in the display device of FIG. 17.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Reference will now be made in detail to embodiments of the present disclosure, examples of which can be illustrated in the accompanying drawings. In the following description, when a detailed description of well-known functions or configurations related to this document is determined to unnecessarily cloud a gist of the inventive concept, the detailed description thereof will be omitted. The progression of processing steps and/or operations described is an example; however, the sequence of steps and/or operations is not limited to that set forth herein and can be changed as is known in the art, with the exception of steps and/or operations necessarily occurring in a particular order. Like reference numerals designate like elements throughout. Names of the respective elements used in the following explanations can be selected only for convenience of writing the specification and can be thus different from those used in actual products.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments can be provided so that this disclosure can be sufficiently thorough and complete to assist those skilled in the art to fully understand the scope of the present disclosure. Further, the present disclosure is only defined by scopes of claims.

Where the terms “comprise,” “have,” “include” and the like are used, one or more other elements can be added unless the terms, such as “only,” is used. An element described in the singular form is intended to include a plurality of elements, and vice versa, unless the context clearly indicates otherwise.

Any implementation described herein as an “example” is not necessarily to be construed as preferred or advantageous over other implementations.

When the relation of a time sequential order is described using the terms such as “after”, “continuously to”, “next to”, and “before”, the order may not be continuous unless the terms are used with the term “immediately” or “directly”.

In the description of the various embodiments of the present disclosure, where positional relationships are described, for example, when a position relation between two parts is described as, for example, “on,” “over,” “under,” and “next,” or the like, one or more other parts can be located between the two parts unless a more limiting term, such as “just” or “direct(ly)” is used. For example, where an element or layer is disposed “on” another element or layer, a third layer or element can be interposed therebetween.

In describing components of the example embodiment of the present disclosure, terminologies such as first, second, A, B, (a), (b), and the like can be used. These terminologies are used to distinguish a component from the other component, but a nature, an order, or the number of the components is not limited by the terminology. When a component is “linked”, “coupled”, or “connected” to another component, the component can be directly linked or connected to the other component. However, unless specifically stated otherwise, it can be understood that a third component can be interposed between the components which can be indirectly linked or connected.

It can be understood that “at least one” includes all combinations of one or more of associated components. For example, “at least one of first, second, and third components” means that not only a first, second, or third component, but also all combinations of two or more of first, second, and third components are included.

In the present specification, a “display device” can include a display device which includes a display panel and a driver for driving the display panel, in a narrow sense, such as a liquid crystal module (LCM), an organic light emitting module (OLED module), and a quantum dot (QD) module. Further, the “display device” or “display apparatus” can further include a set electronic apparatus or a set apparatus (or a set device) which is a complete product or a final product including an LCM, an OLED module, a QD module, etc., such as a notebook computer, a television, or a computer monitor, an automotive display device or equipment display device including another type of vehicle and a mobile electronic apparatus including a smart phone or an electronic pad.

Accordingly, the display device of the present disclosure can include not only a display device itself in a narrow sense such as an LCM, an OLED module, a QD module, etc., but also an applied product or a set apparatus which is a final consumer device including the LCD, the OLED module, the QD module, etc.

Further, in some cases, the LCM, the OLED module, or the QD module which is configured by a display panel and a driver can be represented as “a display device” or “display apparatus” in a narrow sense and an electronic device as a complete product including the LCM, the OLED module, and the QD module can be represented as a “set apparatus”. For example, the display device in the narrow sense includes a liquid crystal (LCD) display panel, an OLED display panel, or a quantum dot display panel and a source PCB which is a controller for driving the display panel. In contrast, the set apparatus can be a concept further including a set PCB which is a set controller which is electrically connected to the source PCB to control the entire set apparatus.

As a display panel used in the example embodiment of the present disclosure, any type of display panel such as a liquid crystal display panel, an organic light emitting diode (OLED) display panel, a quantum dot (QD) display panel, and an electroluminescent display panel can be used. The display panel of the present example embodiment is not limited to a specific display panel in which a bezel is bent with a flexible substrate for the organic light emitting diode (OLED) display panel and a back plate support structure therebelow. Further, a display panel used for the display device according to the example embodiment of the present disclosure is not limited to a shape or a size of the display panel.

For example, when the display panel is an OLED display panel, the display panel can include a plurality of gate lines, data lines, and pixels formed at intersecting areas of the gate lines and/or data lines. Further, the display panel can be configured to include an array including a thin film transistor which is an element to selectively apply a voltage to each pixel, a light emitting diode layer on the array, an encapsulation substrate or an encapsulation layer, and the like disposed on the array so as to cover the light emitting diode layer. The encapsulation layer can protect the thin film transistor the light emitting diode layer, and the like from external impacts and can suppress the permeation of moisture or oxygen into the light emitting diode layer. Further, a layer formed on the array can include an inorganic light emitting layer, for example, a nano-sized material layer quantum dots, or the like.

The features of various example embodiments of the present disclosure can be partially or entirely coupled to or combined with each other and can be interlocked and operated in technically various ways, and the example embodiments can be carried out independently of or in association with each other.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “can” and vice versa.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Rather, these embodiments can be provided so that this disclosure can be sufficiently thorough and complete to assist those skilled in the art to fully understand the scope of the present disclosure.

Hereinafter, the example embodiments of the present disclosure will be described with reference to the accompanying drawings and example embodiments as follows. All the components of each display device according to all embodiments of the present disclosure are operatively coupled and configured. Scales of components illustrated in the accompanying drawings are different from the real scales for the purpose of description, so that the scales are not limited to those illustrated in the drawings.

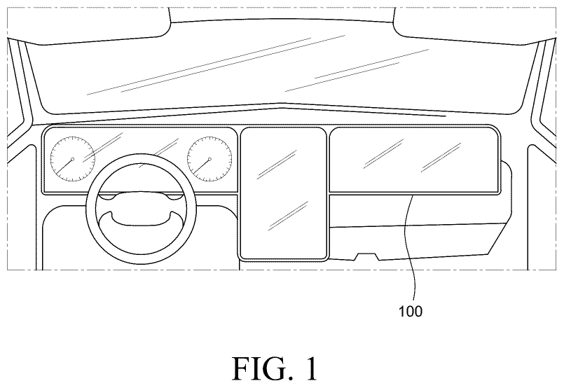

FIG. 1 is an example view of a display device according to an example embodiment of the present disclosure.

Referring to FIG. 1, a display device 100 can be disposed in at least a part of a dash board of a vehicle or any other transportation medium. The dash board of the vehicle includes a configuration disposed in a front surface of front seats (for example, a driver seat and a front passenger seat) of the vehicle. For example, on the dash board of the vehicle, an input configuration for manipulating various functions (for example, an air-conditioner, an audio system, or a navigation system) in the vehicle is disposed.

The display device 100 is disposed on the dash board of the vehicle to operate as an input unit which manipulates at least a part of various functions of the vehicle. The display device 100 can provide various information related to the vehicle, for example, operation information of the vehicle (for example, a current speed of the vehicle, a remaining fuel amount, or a mileage) or information about parts of the vehicle (for example, a damage level of a vehicle tire).

The display device 100 is disposed across the driver seat and the front passenger seat disposed in the front seats of the vehicle. A user of the display device 100 can include a driver of the vehicle and a passenger riding on the front passenger seat. Both the vehicle driver and the passenger use the display device 100.

A part of the display device 100 is illustrated in FIG. 1. The display device 100 illustrated in FIG. 1 illustrates a display panel, among various configurations included in the display device 100. Specifically, for example, the display device 100 illustrated in FIG. 1 illustrates at least a part of an active area and a non-active area of the display panel. Among the configurations of the display device 100, configurations other than the parts illustrated in FIG. 1 can be mounted inside the vehicle (or at least a part of the inside of the vehicle).

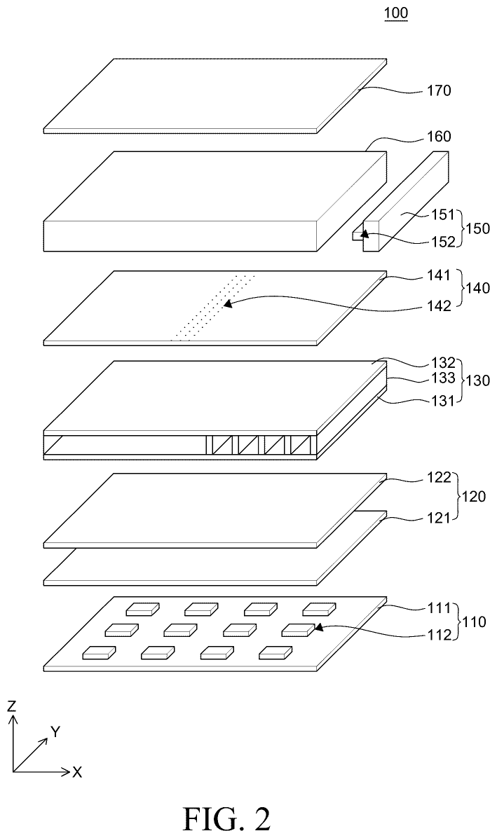

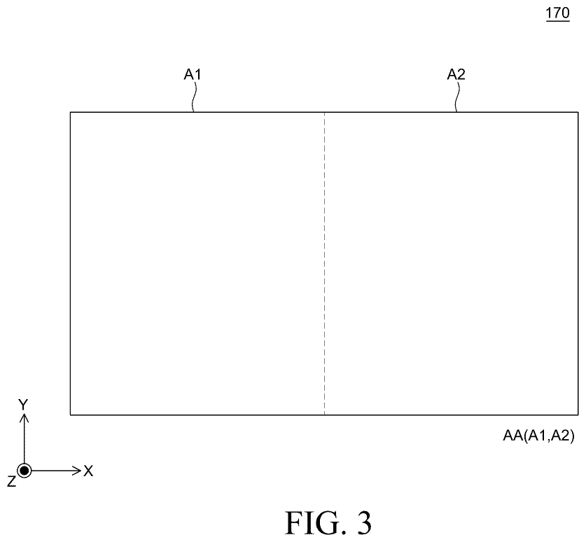

FIG. 2 is an exploded perspective view of a display device according to one or more example embodiments of the present disclosure. FIG. 3 is a view illustrating an example of a display panel of a display device according to an example embodiment of the present disclosure.

In the meantime, for the convenience of description, hereinafter, a horizontal direction on the plain is illustrated as a first direction (e.g., X) and a vertical direction on the plane is illustrated as a second direction (e.g., Y). Further, a normal direction of a plane defined by the first direction X and the second direction Y, for example, a thickness direction of the display device 100 can be defined as a third direction (e.g., Z).

Referring to FIG. 2, the display device 100 according to the example embodiment of the present disclosure includes a first light source unit 110, at least one optical sheet 120, a first light controller 130, a second light controller 140, a second light source unit 150, a light guide plate 160, and a display panel 170.

The display panel 170 generates an image to be provided to a user using light provided from a light source unit disposed therebelow. For example, the display panel 170 adjusts a transmittance for light provided from the first light source unit 110 and/or the second light source unit 150 disposed therebelow to display an image.

As the display panel 170, a liquid crystal display panel can be applied but other type of display panel/device can be used. For example, the display panel 170 can include a bottom substrate, a top substrate which is opposite to the bottom substrate, and a liquid crystal layer disposed between the bottom substrate and the top substrate. Here, the liquid crystal layer can be driven by a vertical field driving method, such as a twisted nematic (TN) mode and a vertical alignment (VA) mode, or a horizontal field driving method, such as an in-plane switching (IPS) mode and a fringe field switching (FFS) mode, but is not limited thereto.

The display panel 170 includes an active area (or display area) in which an image is displayed and a non-active area (or non-display area) which encloses the active area. The non-active area can surround the active area entirely or in part(s). Further, there can be one or more active areas and one or more non-active areas in the display panel 170.

The active area of the display panel 170 is partitioned into a plurality of areas. In other words, the active area includes a plurality of areas.

For example, further referring to FIG. 3, the active area AA of the display panel 170 includes a plurality of areas disposed along the first direction X. For example, the active area AA includes a first area A1 and a second area A2 which is adjacent to the first area A1 in the first direction X.

According to the example embodiment, the first area A1 and the second area A2 of the display panel 170 are disposed across a driver seat and a front passenger seat disposed in front seats of the vehicle which have been described with reference to FIG. 1 to provide various information to a driver and a passenger of the vehicle. Each of the first area A1 and the second area A2 of the display panel 170 displays different information images to the user(s). For example, the first area A1 of the display panel 170 includes an area provided to the driver seat disposed on the front seat of the vehicle and/or an area provided between the driver seat and the front passenger seat, for example, a CID (center information display) area to provide information such as a driving speed, RPM, an engine temperature, and a fuel amount. The second area A2 of the display panel 170 is an area provided to the front passenger seat disposed on the front seat of the vehicle, for example, a CDD (complex device driver) area to provide entertainment functions and seat information for the passenger sitting in the front passenger seat. However, such area division is for the convenience of description and the first area A1 and the second area A2 in the display panel 170 can be defined in various ways depending on the design.

In the meantime, when the display panel 170 is used for the vehicle which has been described with reference to FIG. 1, a field of view of at least partial area of the display panel 170 needs to be restricted according to the user's request. For example, images displayed in the second area A2 which provides the entertainment function and the seat information for the passenger sitting on the front passenger seat can interfere with the driving of the driver. Accordingly, according to the user's request, the field of view of the image displayed in the second area A2 needs to be restricted.

For example, according to the driving mode of the display device 100, in the first mode, both the first area A1 and the second area A2 of the display panel 170 are controlled in a wide field-of-view mode (share mode) to display an image. In the second mode, at least a partial area, among the plurality of areas A1 and A2 of the display panel 170, for example, the second area A2 is controlled in a narrow field-of-view mode (private mode) to display an image. To this end, the display device 100 controls whether to allow the second light source unit 150 disposed on the top, among the plurality of light source units disposed below the display panel 170, to emit light to control the display panel 170 in the first mode or the second mode.

Referring to FIG. 2, a first light source unit 110, at least one optical sheet 120, a first light controller 130, a second light controller 140, a second light source unit 150, and a light guide plate 160 can be disposed below the display panel 170.

The first light source unit 110 generates light and provides the generated light to the third direction Z, for example, toward the optical sheet 120. The first light source unit 110 is disposed below the optical sheet 120. For example, the first light source unit 110 is a direct type backlight assembly.

The first light source unit 110 includes a first circuit board 111 and a plurality of first light sources 112 disposed on the first circuit board 111.

The first circuit board 111 includes a driving circuit which drives the plurality of first light sources 112. The driving circuit of the first circuit board 111 generates an electrical signal to drive the plurality of first light sources 112 and supplies the electrical signal to the plurality of first light sources 112. However, the present disclosure is not limited thereto and the driving circuit can be disposed at the outside of the first circuit board 111.

The plurality of first light sources 112 can be mounted on the first circuit board 111. For example, the plurality of first light sources 112 is disposed on the first circuit board 111 to be spaced apart from each other along the first direction X and the second direction Y to be mounted on a top surface which is one surface of the first circuit board 111. For example, the plurality of first light sources 112 is disposed on the first circuit board 111 in a matrix, but is not limited thereto.

Each of the plurality of first light sources 112 can be formed to emit white light, but is not limited thereto and the plurality of first light sources 112 can be formed to emit light with any one wavelength of red, green, and blue.

As the plurality of first light sources 112, a light emission diode (LED), a cold cathode fluorescent lamp (CCFL), or an external electrode fluorescent lamp can be used, but it is not limited thereto.

At least one optical sheet 120 is disposed on the first light source unit 110. On the first light source unit 110, a plurality of optical sheets which diffuses or condenses light incident from the first light source unit 110 is included.

For example, the optical sheet 120 includes a first optical sheet 121 and a second optical sheet 122. The first optical sheet 121 diffuses light provided from the first light source unit 110 and allows light to travel upwardly, for example, in the third direction Z. For example, the first optical sheet 121 can be a diffusion sheet. The second optical sheet 122 condenses light which has passed through the first optical sheet 121 to allow light to travel upwardly, for example, in the third direction Z. For example, the second optical sheet 122 can be a prism sheet.

However, the present disclosure is not limited thereto and the optical sheet 120 includes another optical sheet, in addition to the first optical sheet 121 and the second optical sheet 122. For example, the optical sheet 120 further includes a luminance improvement sheet, such as a protective sheet or a dual brightness enhancement film (DBEF), or includes a composite optical sheet in which the diffusion sheet and the prism sheet are integrated, instead of the first optical sheet 121 and the second optical sheet 122.

The first light controller 130 is disposed on the optical sheet 120.

The first light controller 130 controls a viewing angle of light provided from the bottom. For example, the first light controller 130 restricts a viewing angle or an emission angle in the first direction X, of light which is emitted from the first light source unit 110 to pass through the optical sheet 120 and travel in the third direction Z which is perpendicular to the active area AA. For example, the first light controller 130 reduces or narrows a profile of light which is emitted from the first light source unit 110 to be incident into the first light controller 130, in the first direction X. In this case, a viewing angle of an image which is displayed by the light in the first direction X can be reduced.

To this end, the first light controller 130 includes a first support member 131, a second support member 132 which is opposite to the first support member 131, and a plurality of partitions 133 which is disposed between the first support member 131 and the second support member 132. In the meantime, the term, partition used in the present disclosure, is used for the convenience of description and can be defined as a term “louver” or a term “viewing angle control pattern”, instead of the partition.

Each of the plurality of partitions 133 extends between the first support member 131 and the second support member 132 in the second direction Y and is spaced apart from each other along the first direction X. In this case, for example, a profile of light which is incident to the first light controller 130, for example, an area spaced between the plurality of partitions 133, is narrowed in the first direction X, by the plurality of partitions 133 disposed to be spaced apart from each other. Most of light which is restricted in the front direction, for example, in the third direction Z, is provided to the display panel 170.

Accordingly, in an area in which the plurality of partitions 133 of the first light controller 130 is disposed, the light is provided in a first range and in an area in which the plurality of partitions 133 of the first light controller 130 is not disposed, the light is provided in a second range which is larger than the first range. Accordingly, in the case of the image which is displayed with light emitted from the first light source unit 110, in an area of the active area AA overlapping an area in which the plurality of partitions 133 of the first light controller 130 is disposed, the image is displayed at the second viewing angle. In an area overlapping the area in which the plurality of partitions 133 is not disposed, the image is displayed at the first viewing angle. The first viewing angle is larger than the second viewing angle. For example, the first viewing angle is defined as a wide viewing angle and the second viewing angle is defined as a narrow viewing angle.

Further, the first light controller 130 controls the viewing angle of the image which is displayed by light emitted from the first light source unit 110 to be different in each area. For example, the first light controller 130 controls a viewing angle of light which is provided from the bottom to travel in the third direction Z in each area of the active area AA. For example, the first light controller 130 controls a viewing angle of the image which is displayed by light emitted from the first light source unit 110 in the second area A2 of the active area AA.

In this case, the plurality of partitions 133 is disposed in an area overlapping the second area A2. Accordingly, in the case of the image displayed by light emitted from the first light source unit 110, in the second area A2 overlapping an area in which the plurality of partitions 133 is disposed, the viewing angle is controlled to the second viewing angle to display an image. In the other area, for example, in the first area A1, the viewing angle is not controlled and the image is displayed at the first viewing angle.

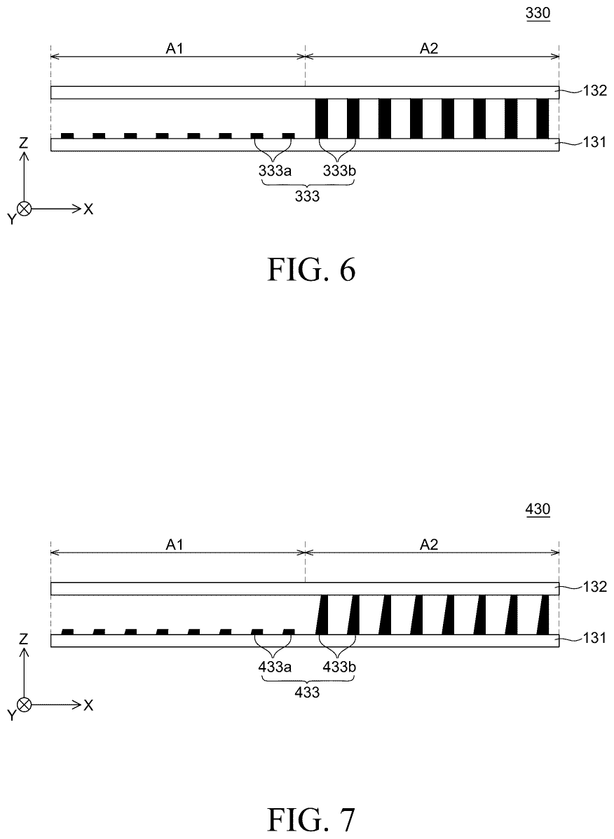

However, this is merely illustrative and the area in which the partition 133 is disposed is not limited thereto. For example, the plurality of partitions 133 is disposed on the entire area overlapping the active area AA. This will be described in detail below with reference to FIGS. 6 to 10B.

The second light controller 140 is disposed on the first light controller 130.

The second light controller 140 controls a profile of light which travels downwardly from the light guide plate 160, for example, in an opposite direction to the third direction Z. For example, the second light controller 140 is disposed between the light guide plate 160 and the first light controller 130 to scatter and/or irregularly reflect light which travels from the light guide plate 160 to the first light controller 130.

To this end, the second light controller 140 includes a base layer 141 and a plurality of light control patterns 142 disposed on the base layer 141. For example, the plurality of light control patterns 142 is disposed in the third area including a boundary line between the first area A1 and the second area A2, for example in an area adjacent to the boundary line between the first area A1 and the second area A2.

The plurality of light control patterns 142 is disposed to be spaced apart from each other on the third area including the boundary line between the first area A1 and the second area A2. For example, the plurality of light control patterns 142 is disposed to be spaced apart from each other with the same or substantially same interval on the third area. However, the placement relationship of the light control pattern 142 is not limited thereto and the plurality of light control patterns 142 is disposed to be spaced apart from each other with the different intervals on the third area.

Each of the plurality of light control patterns 142 has a hemispherical shape. For example, each of the plurality of light control patterns 142 can be a dot pattern. However, the shape of the light control pattern 142 is not limited thereto and each of the plurality of light control patterns 142 can have various shapes, such as an ellipsoid, a rectangular parallelepiped, a cube, or a polyhedron.

Further, a refractive index of each of the plurality of light control patterns 142 can be different from a refractive index of vacuum or air. For example, a refractive index of each of the plurality of light control patterns 142 can be larger than a refractive index of vacuum or air.

Here, light provided from the second light source unit 150 which is refracted in the light guide plate 160 to travel downwardly, for example, light which travels from the light guide plate 160 toward the first light controller 130 is not incident directly onto the first light controller 130, but is incident to the second light controller 140. Therefore, the light is scattered and/or irregularly reflected by the plurality of light control patterns 142. Further, light which is provided from the first light source unit 110 to be incident to the second light controller 140 via the first light controller 130 is scattered and/or irregularly reflected by the plurality of light control patterns 142. Accordingly, the boundary visibility between the first area A1 and the second area A2 can be reduced or minimized.

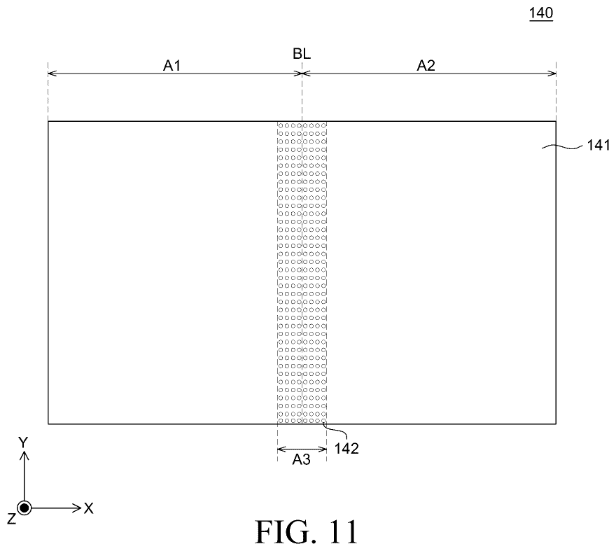

The placement relationship and the shape of the plurality of light control patterns 142 and a configuration which controls the light incident by the light control pattern 142 will be described in detail below with reference to FIGS. 11 to 16.

The second light source unit 150 and the light guide plate 160 are disposed on the second light controller 140.

The second light source unit 150 generates light and provides the generated light to the light guide plate 160. The second light source unit 150 is disposed on a side surface of the light guide plate 160. For example, the second light source unit 150 is an edge type backlight assembly.

The second light source unit 150 includes a second circuit board 151 and a plurality of second light sources 152 disposed on the second circuit board 151.

The second circuit board 151 includes a driving circuit which drives the plurality of second light sources 152. The driving circuit of the second circuit board 151 generates an electrical signal to drive the plurality of second light sources 152 and supplies the electrical signal to the plurality of second light sources 152. However, the present disclosure is not limited thereto and the driving circuit can be disposed at the outside of the second circuit board 151.

The second circuit board 151 is disposed on a side surface of the light guide plate 160. For example, the second circuit board 151 is disposed to be parallel to the light guide plate 160. For example, the second circuit board 151 has a shape which corresponds to one short side of the light guide plate 160 to extend along a length direction of the short side, for example, along the second direction Y. However, the present disclosure is not limited thereto and the second circuit board 151 is disposed so as to correspond to one long side of the light guide plate 160.

Further, the plurality of second light sources 152 can be mounted on the second circuit board 151. For example, the plurality of second light sources 152 is disposed on the second circuit board 151 to be spaced apart from each other along the second direction Y to be mounted on a top surface which is one surface of the second circuit board 151.

Each of the plurality of second light sources 152 can be formed to emit white light, but is not limited thereto and the plurality of second light sources 152 can be formed to emit light with any one wavelength of red, green, and blue.

As the plurality of second light sources 152, a light emission diode (LED), a cold cathode fluorescent lamp (CCFL), or an external electrode fluorescent lamp can be used, but it is not limited thereto.

The light guide plate 160 is disposed on the first light controller 130 and is disposed on a side portion of the second light source unit 150. For example, the light guide plate 160 can be disposed on the substantially same plane as the second light source unit 150.

The light guide plate 160 can be formed of a material including glass, quartz, or polymer having transparency, to efficiently guide the light. For example, the polymer can be formed of a material having a predetermined refractive index, such as acrylic resin including polymethylmethacrylate (PMMA) or polycarbonate (PC).

The light guide plate 160 guides light provided from the second light source unit 150 to allow the light to travel in a direction toward the display panel 170, for example, in the third direction Z. For example, light which is incident from the second light source unit 150, through a side surface on which the second light source unit 150 is disposed, changes the traveling direction to the third direction Z toward the display panel 170, by total reflection, while traveling in the light guide plate 160. Therefore, a uniform surface light source is provided in the display panel 170.

Further, the light which is provided via the optical sheet 120 and the first light controller 130 from the first light source unit 110 travels to the third direction Z which is a direction toward the display panel 170 by means of the light guide plate 160.

In the meantime, as described above, the driving mode of the display device 100 can be controlled depending on whether the second light source 152 included in the second light source unit 150 emits light.

For example, in the first mode, all the plurality of first light sources 112 of the first light source unit 110 and the plurality of second light sources 152 of the second light source unit 150 can emit light. In this case, even though in at least a partial area of the active area AA, for example, in an area overlapping the second area A2, a viewing angle of light emitted from the first light source unit 110 is controlled by the first light controller 130, light emitted from the second light source unit 150 travels by the light guide plate 160 in the third direction Z which is a direction toward the display panel 170 to be provided in the entire active area AA. Therefore, the image is displayed at the first viewing angle in the entire area of the display panel 170. Accordingly, in the first mode, the image is displayed in a wide field-of-view mode (share mode) in the entire active area AA, for example, in both the first area A1 and the second area A2.

Further, in the second mode, the plurality of first light sources 112 of the first light source unit 110 emits light and the plurality of second light sources 152 of the second light source unit 150 does not emit light. Therefore, an image which is displayed by the display panel 170 in the second mode is implemented only by light provided from the first light source unit 110. In this case, in an area of the active area AA which overlaps the second area A2, the viewing angle of the light emitted from the first light source unit 110 is controlled by the first light controller 130. Therefore, in the first area A1 of the display panel 170, the image is displayed at the first viewing angle and in the second area A2 of the display panel 170, the image is displayed at the second viewing angle. Accordingly, in the second mode, the image is displayed in the wide field-of-view mode (share mode) in the first area A1 of the active area AA and the image is displayed in the narrow field-of-view mode (private mode) in the second area A2 of the active area AA.

As described above, the display device 100 according to the example embodiment of the present disclosure controls the second light source unit 150 disposed on the top, among the plurality of light sources disposed below the display panel 170, for example, the first light source unit 110 and the second light source unit 150 to emit light. By doing this, the display device controls the display panel 170 in the first mode or the second mode.

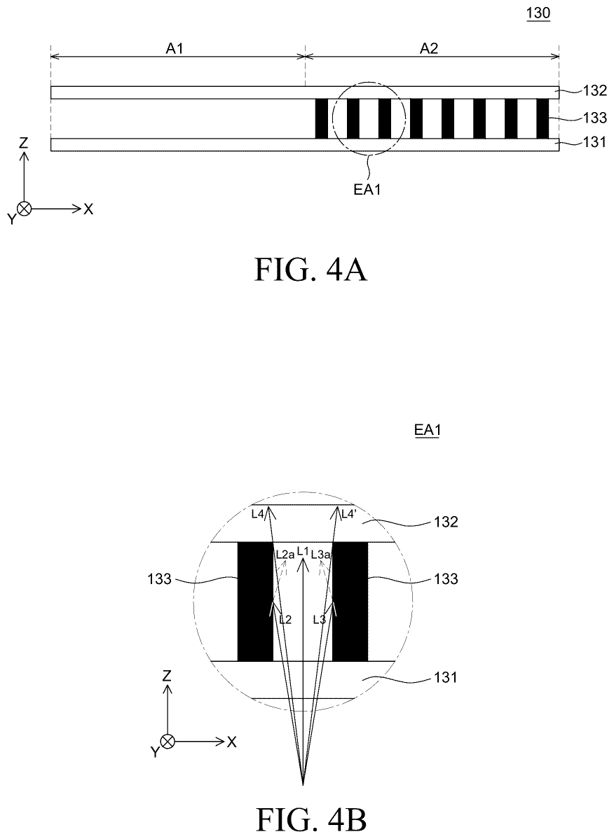

Hereinafter, the first light controller 130 of the display device 100 according to the example embodiments of the present disclosure will be described in more detail with reference to FIGS. 4A to 10B. Further, the second light controller 140 of the display device 100 according to the example embodiments of the present disclosure will be described in more detail with reference to FIGS. 11 to 16.

FIG. 4A is a side view schematically illustrating an example of a first light controller included in the display device of FIG. 2. FIG. 4B is an enlarged view illustrating an example of a part EA1 of FIG. 4A.

In the meantime, the first light controller 130 illustrated in FIG. 4A represents an example of the first light controller 130 included in the display device 100 which has been described with reference to FIG. 2.

Referring to FIGS. 2 and 4A, the first light controller 130 includes a first support member 131, a second support member 132 which is opposite to the first support member 131, and a plurality of partitions 133 disposed between the first support member 131 and the second support member 132. By doing this, the first light controller controls a viewing angle or an emission angle according to the first direction X of light which travels toward the third direction Z which is perpendicular to the active area AA.

The first support member 131 and the second support member 132 are spaced apart from each other with the partition 133 therebetween. The first support member 131 is disposed below the plurality of partitions 133 to support the plurality of partitions 133 and the second support member 132 is disposed above the plurality of partitions 133 to support the plurality of partitions 133. However, it is not limited thereto and bottom surfaces of the plurality of partitions 133 are in contact with the first support member 131 but top surfaces of the plurality of partitions 133 can be spaced apart from the second support member 132.

The first support member 131 and the second support member 132 include transparent material to allow light to pass therethrough. For example, each of the first support member 131 and the second support member 132 includes a plastic member. For example, each of the first support member 131 and the second support member 132 includes polycarbonate. However, the material of each of the first support member 131 and the second support member 132 is not limited thereto. According to the example embodiment, each of the first support member 131 and the second support member 132 includes polymer, such as polystyrene, polyvinyl alcohol, polymethyl methacrylate, polyethersulfone, polyacrylate, polyetherimide, polyethylene naphthalate, polyethylene terephthalate, polyphenylene sulfide, polyarylate, or polyimide.

The plurality of partitions 133 is disposed between the first support member 131 and the second support member 132. In the meantime, each of the plurality of partitions 133 is coupled to the first support member 131 and the second support member 132 by means of a transparent adhesive, but is not limited thereto.

Each of the plurality of partitions 133 extends along the second direction Y and is spaced apart from each other along the first direction X. Accordingly, a space can be formed between the plurality of partitions 133. Such a space can be filled with air or a transparent insulating material, but is not limited thereto.

In the meantime, an interval along the first direction X, between two adjacent partitions 133, among the plurality of partitions 133, is determined by comprehensively considering a thickness of the first light controller 130, an emission angle of light emitted from the first light controller 130, and a distance between the first light controller 130 and the display panel 170. By doing this, the image displayed by the light provided from the first light source unit 110 is displayed on the second area A2 at the second viewing angle.

Each of the plurality of partitions 133 can include a light absorption material or can be coated with a light absorbing agent to absorb light entering from the outside. For example, each of the plurality of partitions 133 includes a carbon based black pigment. However, a material of the plurality of partitions is not limited thereto. Each of the plurality of partitions 133 includes at least one of titanium (Ti), tungsten (W), chromium (Cr), molybdenum (Mo), an alloy of molybdenum (Mo) and titanium (Ti) (MoTi), vanadium (V), niobium (Nb), silicon nitride (SiN), titanium nitride (TiN), silicon carbide (SiC), tantalum (Ta), manganese (Mn), cobalt (Co), nickel (Ni), copper oxide (CuO), aluminum oxide (Al₂O₃), iron oxide (Fe₃O₄), and tantalum oxide (Ta₂O₅) having a high light absorptance or includes an organic material having a high light absorptance.

Further, each of the plurality of partitions 133 can have the rectangular shape on a side surface. For example, each of the plurality of partitions 133 has a rectangular shape as seen from a plane defined by the first direction X and the third direction Z. Therefore, a top surface and a bottom surface of each of the plurality of partitions 133 are parallel to the first support member 131 and the second support member 132. Both side surfaces of the plurality of partitions 133 are perpendicular to the first support member 131 and the second support member 132. For example, both side surfaces of the plurality of partitions 133 can be parallel to the third direction Z which is perpendicular to the first support member 131 and the second support member 132.

An emission angle in the first direction X of light which is emitted from the first light controller 130 is restricted by the plurality of partitions 133. In the meantime, according to the present disclosure, an emission angle refers to an angle formed by a traveling direction of light emitted from the first light controller 130 and the third direction Z on the plane defined by the first direction X and the third direction Z.

To describe in more detail, further referring to FIG. 4B, a profile of light provided from the bottom of the first light controller 130, for example, light supplied from the first light source unit 110 is reduced or narrowed along the first direction X so that the emission angle of the corresponding light in the first direction X can be restricted.

For example, among light provided from the bottom of the first light controller 130, first light L1 having a light path formed in the third direction Z which is a vertical direction, between two separated partitions 133, is not blocked by the partition 133, but can be emitted to the outside, for example, the upward direction of the first light controller 130.

Further, among light provided from the bottom of the first light controller 130, light which passes through the upper end inside of two separated partitions 133, for example, light between fourth light L4 and fourth′ light L4′ can be emitted to an upward direction of the first light controller 130.

However, when a light path is formed in a direction having a predetermined angle along the first direction X with respect to the third direction Z between two separated partitions 133 and the partition 133 is located on the light path, among light provided from the bottom of the first light controller 130, at least some of light can be blocked by the partition 133. For example, light provided from the bottom of the first light controller 130 at an angle larger than an incident angle of the fourth light L4 and fourth′ light L4′ is blocked by the plurality of partitions 133 so as not to be emitted to an upward direction of the first light controller 130. For example, at least some of second light L2 and the third light L3 provided from the bottom of the first light controller 130 is absorbed by the partition 133 and is not emitted to the outside.

In the meantime, in the case of light with a light path on which the partition 133 is located, each of the plurality of partitions 133 includes a light absorption material or is coated with the light absorption agent so that most light is absorbed by the partition 133. However, the remaining light which is not absorbed by the partition 133 is totally reflected from the partition 133 to be emitted to the outside. For example, second light L2a of the second light L2 which is not absorbed by the partition 133 and third light L3a of the third light L3 which is not absorbed by the partition 133 are totally reflected from the partition 133 to be emitted to the outside.

Referring to FIG. 4A, a height of each of the plurality of partitions 133 is substantially same as a length of a space between the first support member 131 and the second support member 132 along the third direction Z. However, the present disclosure is not limited thereto and the height of each of the plurality of partitions 133 along the third direction Z can be smaller than a length of the space between the first support member 131 and the second support member 132 along the third direction Z. In the meantime, in the present disclosure, the height can refer to a length or a distance along the third direction Z.

Further, the plurality of partitions 133 is disposed on the second area A2 and is not disposed on the first area A1. In this case, as described above, in the second area A2 in which the plurality of partitions 133 is disposed, an emission angle of the light in the first direction X is restricted to provide the light in the first range. Further, in the first area A1 in which the plurality of partitions 133 is not disposed, an emission angle of the light is not restricted to provide the light in the second range which is larger than the first range. Accordingly, in the case of an image which is displayed by light emitted from the first light source unit 110 disposed below the first light controller 130, in the second area A2 of the active area AA overlapping an area in which the plurality of partitions 133 is disposed, the image is displayed at the second viewing angle, for example, at a narrow viewing angle. Further, in the first area A1 overlapping an area in which the plurality of partitions 133 is not disposed, the image is displayed at the first viewing angle, for example, at a wide viewing angle.

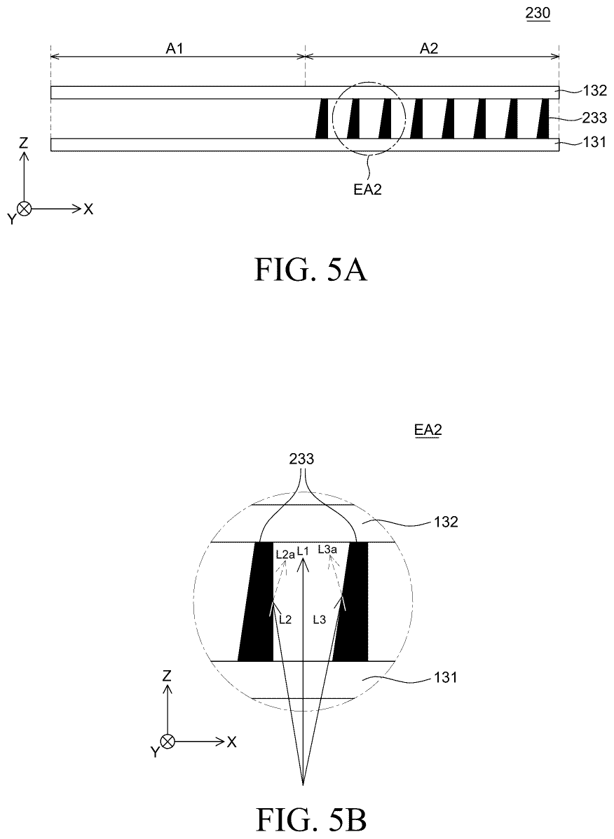

FIG. 5A is a side view schematically illustrating another example of a first light controller included in the display device of FIG. 2. FIG. 5B is an enlarged view illustrating an example of a part EA2 of FIG. 5A.

In the meantime, the first light controller 230 illustrated in FIG. 5A represents another example of the first light controller 130 included in the display device 100 which has been described with reference to FIG. 2.

Further, FIGS. 5A and 5B illustrate a modified example of the example of FIGS. 4A and 4B with regard to a shape of a plurality of partitions 233 included in a first light controller 230. Accordingly, in FIGS. 5A and 5B, in order to avoid a redundant description, differences from the above-described example embodiments will be mainly described.

Referring to FIGS. 2 and 5A, the first light controller 230 includes a first support member 131, a second support member 132 which is opposite to the first support member 131, and a plurality of partitions 233 disposed between the first support member 131 and the second support member 132. By doing this, the first light controller controls a viewing angle or an emission angle according to the first direction X of light which travels toward the third direction Z which is perpendicular to the active area AA.

The plurality of partitions 233 is disposed between the first support member 131 and the second support member 132. For example, each of the plurality of partitions 233 extends along the second direction Y and is spaced apart from each other along the first direction X. Accordingly, a space can be formed between the plurality of partitions 233.

Further, each of the plurality of partitions 233 can have the trapezoidal shape on a side surface. For example, each of the plurality of partitions 233 has a trapezoidal shape as seen from a plane defined by the first direction X and the third direction Z. Accordingly, a top surface and a bottom surface of each of the plurality of partitions 233 are parallel to the first support member 131 and the second support member 132. One side surface of each of the plurality of partitions is perpendicular to the first support member 131 and the second support member 132 and the other side surface of each of the plurality of partitions has an inclined plane at a predetermined angle with respect to the first support member 131 and the second support member 132. For example, one side surface located closer to the first direction X, between both side surfaces of each of plurality of partitions 233, is parallel to the third direction Z which is perpendicular to the first support member 131 and the second support member 132. The other side surface located in the opposite direction to the first direction X, between both side surfaces of each of plurality of partitions 233, has an inclined plane at a predetermined angle with respect to the third direction Z.

Accordingly, an emission angle of light emitted from the first light controller 230 in the first direction X can be more effectively restricted by the plurality of partitions 233 having a trapezoidal shape on the side surface.

To describe in more detail, further referring to FIG. 5B, a profile of light provided from the bottom of the first light controller 230, for example, light supplied from the first light source unit 110 is reduced or narrowed along the first direction X so that the emission angle of the corresponding light in the first direction X can be restricted.

Specifically, among light provided from the bottom of the first light controller 230, when a light path is formed in a direction having a predetermined angle along the first direction X with respect to the third direction Z, between two separated partitions 233, and the inclined side surface of the partition 233 is located on the light path, if the remaining light of light which is not absorbed by the partition 233 is totally reflected, the light can be guided more toward the third direction Z which is a vertical direction, as compared with the case when the light is totally reflected by a vertical side surface of the partition 233. For example, at least a part of the second light L2 which is provided from the bottom of the first light controller 230 to travel to the vertical side surface of the partition 233 is absorbed by the partition 233 and second light L2a which is not absorbed by the partition 233 is totally reflected from the vertical side surface of the partition 233. At least a part of the third light L3 which is provided from the bottom of the first light controller 230 to travel to the inclined side surface of the partition 233 is absorbed by the partition 233 and third light L3a which is not absorbed by the partition 233 is totally reflected from the inclined side surface of the partition 233. Here, depending on an incident angle on the vertical side surface and the inclined side surface of the partition 233, the third light L3a which is totally reflected by the inclined side surface of the partition 233 is guided to the third direction Z which is a vertical direction more than the second light L2a which is totally reflected by the vertical side surface of the partition 233. Accordingly, more light which is directed to the display panel 170 in the second area A2 is condensed.

Further, the third light L3a which is totally reflected by the inclined side surface of the partition 233 travels toward the opposite direction to the first direction X in which the first area A1 is located. When the third light is totally reflected, the third light is more guided to the third direction which is a vertical direction by the incident angle by the inclined side surface. Accordingly, as compared with the third light L3a which is totally reflected by the vertical side surface of the partition 133 which has been described with reference to FIG. 4A, the third light L3a which is totally reflected by the inclined side surface of the partition 233 which has been described with reference to FIG. 5A, can be more shifted to the first direction X. Accordingly, in the case of the image which is displayed by the light provided from the first light source unit 110 on the second area A2, a viewing angle to the first area A1 can be more effectively restricted.

FIG. 6 is a side view schematically illustrating still another example of a first light controller included in the display device of FIG. 2.

In the meantime, a first light controller 330 illustrated in FIG. 6 represents still another example of the first light controller 130 included in the display device 100 which has been described with reference to FIG. 2.

Further, FIG. 6 illustrates a modified example of the example embodiment of FIG. 4A with regard to an area in which a plurality of partitions 333 included in the first light controller 330 is disposed. Accordingly, in FIG. 6, in order to avoid a redundant description, differences from the above-described example embodiments will be mainly described.

Referring to FIGS. 2 and 6, the first light controller 330 includes a first support member 131, a second support member 132 which is opposite to the first support member 131, and a plurality of partitions 333 disposed between the first support member 131 and the second support member 132. By doing this, the first light controller controls a viewing angle or an emission angle according to the first direction X of light which travels toward the third direction Z which is perpendicular to the active area AA.

The plurality of partitions 333 is disposed on the entire active area AA. For example, the plurality of partitions 333 includes a plurality of first partitions 333a disposed on the first area A1 and a plurality of second partitions 333b disposed on the second area A2.

The plurality of first partitions 333a is disposed between the first support member 131 and the second support member 132 on the first area A1. For example, each of the plurality of first partitions 333a extends along the second direction Y and is spaced apart from each other along the first direction X. Accordingly, a space can be formed between the plurality of first partitions 333a.

The plurality of second partitions 333b is disposed between the first support member 131 and the second support member 132 on the second area A2. For example, each of the plurality of second partitions 333b extends along the second direction Y and is spaced apart from each other along the first direction X. Accordingly, a space can be formed between the plurality of second partitions 333b.

For example, each of the plurality of first partitions 333a and the plurality of second partitions 333b can have a rectangular shape on the side surface. For example, each of the plurality of first partitions 333a and the plurality of second partitions 333b has a rectangular shape as seen from a plane defined by the first direction X and the third direction Z.

A height of the first partition 333a is different from a height of the second partition 333b. For example, the height of the first partition 333a is smaller than the height of the second partition 333b. For example, as described with reference to FIGS. 4A and 4B, a height of each of the plurality of second partitions 333b disposed on the second area A2 is substantially equal to or smaller than the length of the space between the first support member 131 and the second support member 132 along the third direction Z. Further, the height of each of the plurality of first partitions 333a disposed on the first area A1 can be designed to have the smallest height which is available by the process.

As described above, the plurality of first partitions 333a has a very small height so that an emission angle of light which is incident to the first area A1 may not be substantially restricted. Accordingly, in the first area A1 in which the plurality of first partition 333a is disposed, the light can be provided in the second range which is larger than the first range. Accordingly, in the case of an image which is displayed by light emitted from the first light source unit 110 disposed below the first light controller 330, in the second area A2 of the active area AA overlapping an area in which the plurality of second partitions 333b is disposed, the image is displayed at the second viewing angle, for example, at a narrow viewing angle. Further, in the first area A1 overlapping an area in which the plurality of first partitions 333a having a very small height is disposed, the image is displayed at the first viewing angle, for example, at a wide viewing angle.

Further, the partition is not formed only in a partial area of the active area AA, but the plurality of partitions 333 is formed in the entire area of the active area AA, during the manufacturing process of the first light controller 330 so that the manufacturing process of the first light controller 330 can be more simplified.

FIG. 7 is a side view schematically illustrating still another example of a first light controller included in the display device of FIG. 2.

In the meantime, a first light controller 430 illustrated in FIG. 7 represents still another example of the first light controller 130 included in the display device 100 which has been described with reference to FIG. 2.

Further, FIG. 7 illustrates a modified example of the example embodiment of FIG. 5A with regard to an area in which a plurality of partitions 433 included in the first light controller 430 is disposed. Accordingly, in FIG. 7, in order to avoid a redundant description, differences from the above-described example embodiments will be mainly described.

Referring to FIGS. 2 and 7, the first light controller 430 includes a first support member 131, a second support member 132 which is opposite to the first support member 131, and a plurality of partitions 433 disposed between the first support member 131 and the second support member 132. By doing this, the first light controller controls a viewing angle or an emission angle according to the first direction X of light which travels toward the third direction Z which is perpendicular to the active area AA.

The plurality of partitions 433 is disposed on the entire active area AA. For example, the plurality of partitions 433 includes a plurality of first partitions 433a disposed on the first area A1 and a plurality of second partitions 433b disposed on the second area A2.

The plurality of first partitions 433a is disposed between the first support member 131 and the second support member 132 on the first area A1. For example, each of the plurality of first partitions 433a extends along the second direction Y and is spaced apart from each other along the first direction X. Accordingly, a space can be formed between the plurality of first partitions 433a.

The plurality of second partitions 433b is disposed between the first support member 131 and the second support member 132 on the second area A2. For example, each of the plurality of second partitions 433b extends along the second direction Y and is spaced apart from each other along the first direction X. Accordingly, a space can be formed between the plurality of second partitions 433b.

Further, each of the plurality of first partitions 433a and the plurality of second partitions 433b can have a trapezoidal shape on the side surface. For example, each of the plurality of first partitions 433a and the plurality of second partitions 433b has a trapezoidal shape as seen from a plane defined by the first direction X and the third direction Z.

A height of the first partition 433a is different from a height of the second partition 433b. For example, the height of the first partition 433a is smaller than the height of the second partition 433b. For example, a height of each of the plurality of second partitions 433b disposed on the second area A2 is substantially equal to or smaller than the length of the space between the first support member 131 and the second support member 132 along the third direction Z. Further, the height of each of the plurality of first partitions 433a disposed on the first area A1 can be designed to have the smallest height which is available by the process.

As described above, the plurality of first partitions 433a has a very small height so that an emission angle of light which is incident to the first area A1 may not be substantially restricted. Accordingly, in the first area A1 in which the plurality of first partition 433a is disposed, the light can be provided in the second range which is larger than the first range. Accordingly, in the case of an image which is displayed by light emitted from the first light source unit 110 disposed below the first light controller 430, in the second area A2 of the active area AA overlapping an area in which the plurality of second partitions 433b is disposed, the image is displayed at the second viewing angle, for example, at a narrow viewing angle. Further, in the first area A1 overlapping an area in which the plurality of first partitions 433a having a very small height is disposed, the image is displayed at the first viewing angle, for example, at a wide viewing angle.

Further, the partition is not formed only in a partial area of the active area AA, but a plurality of partitions 433 is formed in the entire area of the active area AA, during the manufacturing process of the first light controller 430 so that the manufacturing process of the first light controller 433 can be more simplified.

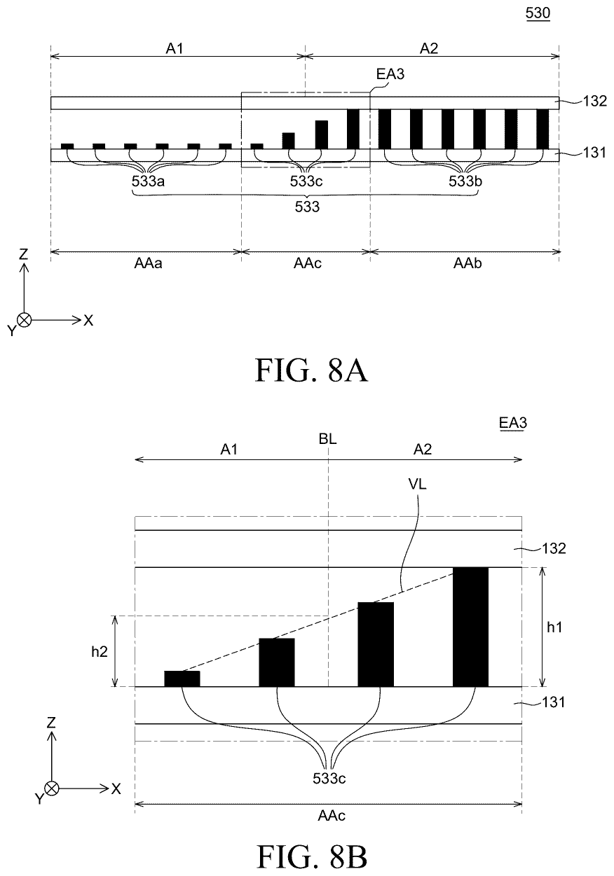

FIG. 8A is a side view schematically illustrating still another example of a first light controller included in the display device of FIG. 2. FIG. 8B is an enlarged view illustrating an example of a part EA3 of FIG. 8A.

In the meantime, a first light controller 530 illustrated in FIG. 8A represents still another example of the first light controller 130 included in the display device 100 which has been described with reference to FIG. 2.

Further, FIG. 8A illustrates a modified example of the example embodiment of FIG. 6 with regard to a height of a plurality of partitions 533 included in the first light controller 530. Accordingly, in FIGS. 8A and 8B, in order to avoid a redundant description, differences from the above-described example embodiments will be mainly described.

Referring to FIGS. 2 and 8A, the first light controller 530 includes a first support member 131, a second support member 132 which is opposite to the first support member 131, and a plurality of partitions 533 disposed between the first support member 131 and the second support member 132. By doing this, the first light controller controls a viewing angle or an emission angle according to the first direction X of light which travels toward the third direction Z which is perpendicular to the active area AA.

In the meantime, referring to FIG. 8A, the active area AA is divided into a plurality of sub areas. For example, the active area AA is divided into a first sub area AAa, a second sub area AAb, and a third sub area AAc. Here, the first sub area AAa corresponds to a partial area of the first area A1, the second sub area AAb corresponds to a partial area of the second area A2, and the third sub area AAc is an area which is disposed between the first sub area AAa and the second sub area AAb and includes a boundary between the first sub area AAa and the second sub area AAb. The third sub area is defined as an area including an area excluding the first sub area AAa from the first area A1 and an area excluding the second sub area AAb from the second area A2.

The plurality of partitions 533 is disposed on the first sub area AAa, the second sub area AAb, and the third sub area AAc of the active area AA. For example, the plurality of partitions 533 includes a plurality of first partitions 533a disposed on the first sub area AAa, a plurality of second partitions 533b disposed on the second sub area AAb, and a plurality of third partitions 533c disposed on the third sub area AAc.

The plurality of first partitions 533a is disposed between the first support member 131 and the second support member 132 on the first sub area AAa. For example, each of the plurality of first partitions 533a extends along the second direction Y and is spaced apart from each other along the first direction X. Accordingly, a space can be formed between the plurality of first partitions 533a.

The plurality of second partitions 533b is disposed between the first support member 131 and the second support member 132 on the second sub area AAb. For example, each of the plurality of second partitions 533b extends along the second direction Y and is spaced apart from each other along the first direction X. Accordingly, a space can be formed between the plurality of second partitions 533b.

The plurality of third partitions 533c is disposed between the first support member 131 and the second support member 132 on the third sub area AAc. For example, each of the plurality of third partitions 533c extends along the second direction Y and is spaced apart from each other along the first direction X. Accordingly, a space can be formed between the plurality of third partitions 533c.

For example, each of the plurality of first partitions 533a, the plurality of second partitions 533b, and the plurality of third partitions 533c can have a rectangular shape on the side surface. For example, each of the plurality of first partitions 533a, the plurality of second partitions 533b, and the plurality of third partitions 533c has a rectangular shape as seen from a plane defined by the first direction X and the third direction Z.

A height of the first partition 533a is different from a height of the second partition 533b. For example, the height of the first partition 533a is smaller than the height of the second partition 533b. For example, a height of each of the plurality of second partitions 533b disposed on the second sub area AAb is substantially equal to the length of the space between the first support member 131 and the second support member 132 along the third direction Z. Further, the height of each of the plurality of first partitions 533a disposed on the first sub area AAa can be designed to have the smallest height which is available by the process.

For example, the height of the plurality of third partitions 533c is gradually increased toward the first direction X. For example, the height of the plurality of third partitions 533c is gradually increased from the first area A1 or the first sub area AAa to the second area A2 or the second sub area AAb. For example, a third partition 533c, among the plurality of third partitions 533c, which is the most adjacent to the first sub area AAa has the same or substantially same height as the first partition 533a. A third partition 533c, among the plurality of third partitions 533c, which is the most adjacent to the second sub area AAb has the same or substantially same height as the second partition 533b. The remaining third partition 533c, among the plurality of third partitions 533c, has a height between the first partition 533a and the second partition 533b and is increased toward the first direction X.

In other words, the height of the plurality of partitions 533 is gradually increased from the vicinity of the boundary between the first area A1 and the second area A2 toward the first direction X, for example, toward the second sub area AAb. Accordingly, in the case of the image which is displayed by light which is incident to the first light controller 530, a boundary visibility according to a viewing angle difference of the first area A1 and the second area A2 can be reduced or minimized in the boundary portion between the second area A2 and the first area A1. In the second area A2, a viewing angle is entirely restricted to display an image at a second viewing angle, for example, a narrow viewing angle and in the first area A1, the viewing angle is not substantially restricted to display an image at a first viewing angle, for example, a wide viewing angle.

In the meantime, the boundary between the first area A1 and the second area A2 of the active area AA is defined in the third sub area AAc. In order to describe this in more detail, further referring to FIG. 8B, on a virtual line VL connecting center points of top surfaces of the plurality of third partitions 533c, a straight line parallel to the third direction Z, with respect to a point where a height from the first support member 131 is a second height h2 which is half the first height h1 which is the height of the second partition 533b disposed on the second area A2, can be defined as the boundary line BL between the first area A1 and the second area A2. However, it is merely illustrative to divide the first area A1 and the second area A2 in the active area AA along the boundary line BL and the first area A1 and the second area A2 in the active area AA can be defined in various ways depending on the design. For example, depending on the design, on the virtual line VL connecting center points of top surfaces of the plurality of third partitions 533c, a straight line parallel to the third direction Z based on a point having a height equal to ⅔ of the first height h1 on the above-described virtual line VL can be defined as the boundary line BL between the first area A1 and the second area A2.

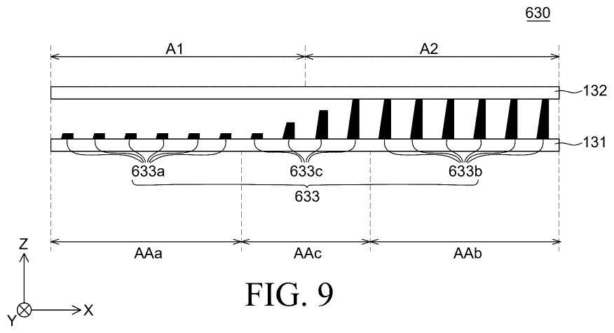

FIG. 9 is a side view schematically illustrating still another example of a first light controller included in the display device of FIG. 2.

In the meantime, a first light controller 630 illustrated in FIG. 9 represents still another example of the first light controller 130 included in the display device 100 which has been described with reference to FIG. 2.

Further, FIG. 9 illustrates a modified example of the example embodiment of FIG. 7 with regard to a height of a plurality of partitions 633 included in the first light controller 630. Accordingly, in FIG. 9, in order to avoid a redundant description, differences from the above-described example embodiments will be mainly described.

Referring to FIGS. 2 and 9, the first light controller 630 includes a first support member 131, a second support member 132 which is opposite to the first support member 131, and a plurality of partitions 633 disposed between the first support member 131 and the second support member 132. By doing this, the first light controller controls a viewing angle or an emission angle according to the first direction X of light which travels toward the third direction Z which is perpendicular to the active area AA.

In the meantime, referring to FIG. 9, the active area AA is divided into a plurality of sub areas. Here, the plurality of sub areas, for example, the area division of the first sub area AAa, the second sub area AAb, and the third sub area AAc is substantially the same as or similar to the area division which has been described with reference to FIG. 8A so that a redundant description will not be repeated.

The plurality of partitions 633 is disposed on the active area AA. For example, the plurality of partitions 633 includes a plurality of first partitions 633a disposed on the first sub area AAa, a plurality of second partitions 633b disposed on the second sub area AAb, and a plurality of third partitions 633c disposed on the third sub area AAc.

The plurality of first partitions 633a is disposed between the first support member 131 and the second support member 132 on the first sub area AAa. For example, each of the plurality of first partitions 633a extends along the second direction Y and is spaced apart from each other along the first direction X. Accordingly, a space can be formed between the plurality of first partitions 633a.

The plurality of second partitions 633b is disposed between the first support member 131 and the second support member 132 on the second sub area AAb. For example, each of the plurality of second partitions 633b extends along the second direction Y and is spaced apart from each other along the first direction X. Accordingly, a space can be formed between the plurality of second partitions 633b.

The plurality of third partitions 633c is disposed between the first support member 131 and the second support member 132 on the third sub area AAc. For example, each of the plurality of third partitions 633c extends along the second direction Y and is spaced apart from each other along the first direction X. Accordingly, a space can be formed between the plurality of third partitions 633c.

For example, each of the plurality of first partitions 633a, the plurality of second partitions 633b, and the plurality of third partitions 633c can have a trapezoidal shape on the side surface. For example, each of the plurality of first partitions 633a, the plurality of second partitions 633b, and the plurality of third partitions 633c has a trapezoidal shape as seen from a plane defined by the first direction X and the third direction Z.

A height of the first partition 633a is different from a height of the second partition 633b. For example, the height of the first partition 633a is smaller than the height of the second partition 633b. For example, a height of each of the plurality of second partitions 633b disposed on the second sub area AAb is substantially equal to the length of the space between the first support member 131 and the second support member 132 along the third direction Z. Further, the height of each of the plurality of first partitions 633a disposed on the first sub area AAa can be designed to have the smallest height which is available by the process.

Further, the height of the plurality of third partitions 633c is gradually decreased toward the opposite direction to the first direction X. For example, a third partition 633c, among the plurality of third partitions 633c, which is the most adjacent to the second sub area AAb has the same or substantially same height as the second partition 633b. A third partition 633c, among the plurality of third partitions 633c, which is the most adjacent to the first sub area AAa has the same or substantially same height as the first partition 633a. The remaining third partition 633c, among the plurality of third partitions 633c, has a height between the first partition 633a and the second partition 633b and is decreased toward the opposite direction to the first direction X. Accordingly, in the case of the image displayed by light which is incident to the first light controller 630, the boundary visibility according to the viewing angle difference of the first area A1 and the second area A2 in the boundary portion between the first area A1 and the second area A2 can be reduced or minimized.

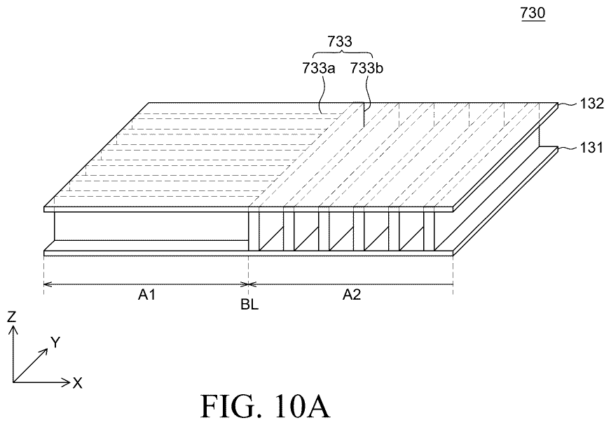

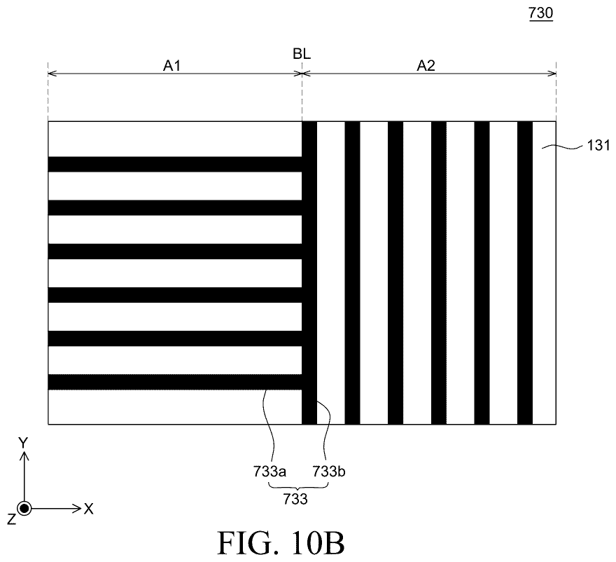

FIG. 10A is a perspective view schematically illustrating still another example of a first light controller included in the display device of FIG. 2. FIG. 10B is a plan view schematically illustrating still another example of a first light controller included in the display device of FIG. 2.

In the meantime, a first light controller 730 illustrated in FIGS. 10A and 10B represents still another example of the first light controller 130 included in the display device 100 which has been described with reference to FIG. 2.

Further, FIGS. 10A and 10B illustrate a modified example of the example embodiment of FIG. 4A with regard to an area in which a plurality of partitions 733 included in the first light controller 730 is disposed. Accordingly, in FIGS. 10A and 10B, in order to avoid a redundant description, differences from the above-described example embodiments will be mainly described.

Referring to FIGS. 2, 10A, and 10B, the first light controller 730 includes a first support member 131, a second support member 132 which is opposite to the first support member 131, and a plurality of partitions 733 disposed between the first support member 131 and the second support member 132. By doing this, the first light controller controls a viewing angle or an emission angle according to the first direction X of light which travels toward the third direction Z which is perpendicular to the active area AA.

The plurality of partitions 733 is disposed on the entire active area AA. For example, the plurality of partitions 733 includes a plurality of first partitions 733a disposed on the first area A1 and a plurality of second partitions 733b disposed on the second area A2. The plurality of first partitions 733a and the plurality of second partitions 733b can extend in different directions.

The plurality of first partitions 733a is disposed between the first support member 131 and the second support member 132 on the first area A1. For example, each of the plurality of first partitions 733a extends along the first direction X and is spaced apart from each other along the second direction Y. Accordingly, a space can be formed between the plurality of first partitions 733a.

The plurality of second partitions 733b is disposed between the first support member 131 and the second support member 132 on the second area A2. For example, each of the plurality of second partitions 733b extends along the second direction Y and is spaced apart from each other along the first direction X. Accordingly, a space can be formed between the plurality of second partitions 733b.

In the meantime, as illustrated in FIG. 10B, each of the plurality of partitions 733a is formed to extend to the boundary line BL along the first direction X on the first area A1 to be in contact with the second partition 733b, among the plurality of partitions 733b disposed on the second area A2, which is the most adjacent to the boundary line BL. However, it is not limited thereto.

For example, each of the plurality of first partitions 733a and the plurality of second partitions 333b can have a shape of a square pillar. Therefore, each of the plurality of first partitions 733a and the plurality of second partitions 733b can have a rectangular shape on the side surface. For example, the plurality of first partitions 733a has a rectangular shape as seen from one side surface of the first light controller 730 defined by the second direction Y and the third direction Z. The plurality of second partitions 733b has a rectangular shape as seen from the other side surface of the first light controller 730 defined by the first direction X and the third direction Z.

As described above, the plurality of first partitions 733a has a shape of a square pillar extending in the first direction so that an emission angle of light which is incident to the first area A1 may not be substantially restricted. Accordingly, in the first area A1 in which the plurality of first partition 733a is disposed, the light can be provided in the second range which is larger than the first range. Accordingly, in the case of an image which is displayed by light emitted from the first light source unit 110 disposed below the first light controller 730, in the second area A2 of the active area AA overlapping an area in which the plurality of second partitions 733b is disposed, the image is displayed at the second viewing angle, for example, at a narrow viewing angle. Further, in the first area A1 overlapping an area in which the plurality of first partitions 733a having a shape of a square pillar extending in the first direction X is disposed, the emission angle in the first direction X is not restricted by the plurality of first partitions 733a so that the image is displayed at the first viewing angle, for example, at a wide viewing angle.

Further, the plurality of partitions 733, for example, the plurality of first partitions 733a is disposed not only in the second area A2, but also in the first area A1, so that a color difference in each area of the displayed image which can be generated when the partition is disposed only on the second area A2 can be reduced or minimized.

FIG. 11 is a plan view schematically illustrating an example of a second light controller included in the display device of FIG. 2.

Referring to FIG. 11, the second light controller 140 includes a base layer 141 and a plurality of light control patterns 142 disposed on the base layer 141.

The base layer 141 supports a plurality of light control patterns 142.

The base layer 141 includes a transparent material to allow light to pass therethrough. For example, the base layer 141 includes a plastic material. For example, the base layer 141 includes polyethylene terephthalate or polycarbonate. However, the material of the base layer 141 is not limited thereto and depending on the example embodiment, the base layer 141 can include a polymer, such as polystyrene, polyvinyl alcohol, polymethyl methacrylate, polyethersulfone, polyacrylate, polyetherimide, polyethylene naphthalate, polyphenylene sulfide, polyarylate, or polyimide.

A plurality of light control patterns 142 can be disposed on the base layer 141. For example, the plurality of light control patterns 142 can be formed by a printing process which sprays ink on an area in which the light control pattern 142 is disposed, for example, on the third area A3. However, this is just illustrative and the manufacturing process of the light control pattern 142 is not limited thereto and the plurality of light control patterns 142 can be formed by various manufacturing processes.

The plurality of light control patterns 142 is disposed in the third area A3. Here, referring to FIG. 11, the third area A3 is defined as an area including a boundary line BL between the first area A1 and the second area A2. For example, the third area A3 can be an area including at least a partial area of the first area A1 adjacent to the boundary line BL and at least a partial area of the second area A2 adjacent to the boundary line BL.

As described above, the plurality of light control patterns 142 is disposed on the third area which is adjacent to the boundary line BL between the first area A1 and the second area A2. However, this is merely illustrative and the area in which the light control pattern 142 is disposed is not limited thereto. For example, the plurality of light control patterns 142 can be disposed in the entire active area AA, for example, the entire first area A1 and second area A2.

The plurality of light control patterns 142 is disposed on the third area A3 to be spaced apart from each other.

Further, the plurality of light control patterns 142 is disposed on the third area A3 to be spaced apart from each other with the same or substantially same interval. For example, the plurality of light control patterns 142 is disposed on the third area A3 with a constant density and a constant interval. In the meantime, in the present disclosure, the density with which the light control patterns 142 are disposed is defined as a percentage (%) of an area in which the light control patterns 142 are disposed with respect to the entire area of the unit area.

Each of the plurality of light control patterns 142 includes a plastic material including a transparent material to allow light to pass therethrough. Further, each of the plurality of light control patterns 142 can have a material having a refractive index which is different from that of vacuum or air, for example, having a refractive index higher than the refractive index of vacuum or air to scatter and/or totally reflect light emitted from the second light controller 140 on the third area A3 in which the plurality of light control patterns 142 is disposed.

For example, the plurality of light control patterns 142 can have the same or substantially same material as the base layer 141. For example, the plurality of light control patterns 142 includes polyethylene terephthalate or polycarbonate. However, the material of the plurality of light control patterns 142 is not limited thereto and each of the plurality of light control patterns 142 can include a transparent material, such as polystyrene, polyvinyl alcohol, polymethyl methacrylate, polyethersulfone, polyacrylate, polyetherimide, polyethylene naphthalate, polyphenylene sulfide, polyarylate, or polyimide. Further, the plurality of light control patterns 142 can be formed by including various known materials having a refractive index which is higher than the refractive index of vacuum or air.

Further, depending on the example embodiment, each of the plurality of light control patterns 142 can include a light scattering material or light scattering particles to more effectively scatter the incident light. For example, each of the plurality of light control patterns 142 can include a light scattering material or light scattering particles including an organic material such as polystyrene or a derivative thereof, an acrylic resin or a derivative thereof, a silicone resin or a derivative thereof, or a novolac resin or a derivative thereof, or an inorganic material such as silica, alumina, titanium oxide or zirconium oxide. However, the material of the light scattering material or the light scattering particles is not limited thereto. As described above, when the plurality of light control patterns 142 can include a light scattering material or light scattering particles, the light can be scattered in a random direction, regardless of the incident direction of the incident light, without substantially changing a peak wavelength of the incident light.

Each of the plurality of light control patterns 142 has a hemispherical shape. For example, each of the plurality of light control patterns 142 can be a dot pattern. However, the shape of the light control pattern 142 is not limited thereto and each of the plurality of light control patterns 142 can have various shapes, such as an ellipsoid, a rectangular parallelepiped, a cube, or a polyhedron.

The plurality of light control patterns 142 has the same or substantially same size. For example, the plurality of light control patterns 142 having a hemispherical shape can have the same or substantially same radius. Depending on the example embodiment, a size of each of the plurality of light control patterns 142, for example, a radius of each of the plurality of light control patterns 142 can have a size between several micrometers and several hundred micrometers, but the size of each of the plurality of light control patterns 142 is not limited thereto.

In the meantime, the interval of the plurality of light control patterns 142, a size or a radius of the plurality of light control patterns 142 can be designed by considering a transmittance of the light control pattern 142 or a width of a third area A3 in which the light control pattern 142 is disposed. For example, the interval of the plurality of light control patterns 142, a size or a radius of the plurality of light control patterns 142 can be designed by considering a transmittance of the light control pattern 142 or a width of a third area A3 in which the light control pattern 142 is disposed such that light which travels downwardly from the light guide plate 160, for example, light which is travels from the light guide plate 160 to the first light controller 130 to be incident onto the third area A3 of the area of the second light controller 140 in which the plurality of light control patterns 142 is disposed is scattered and/or totally reflected by the plurality of light control patterns 142.

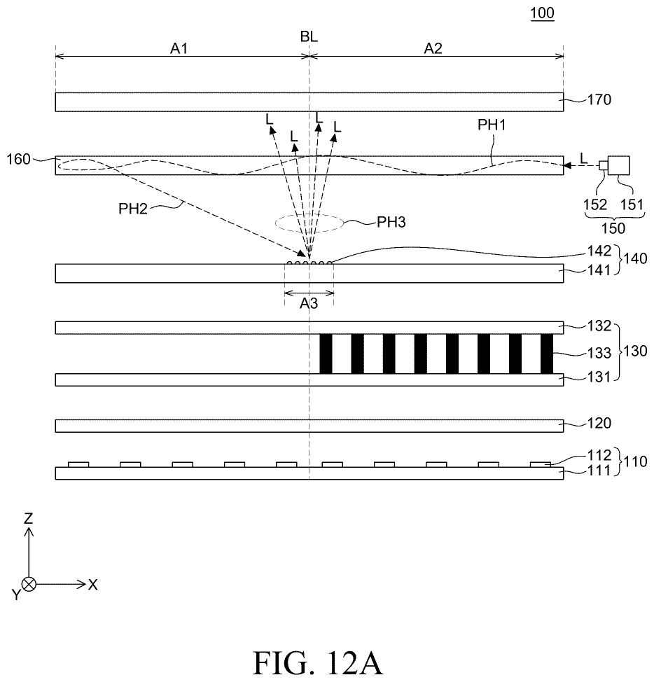

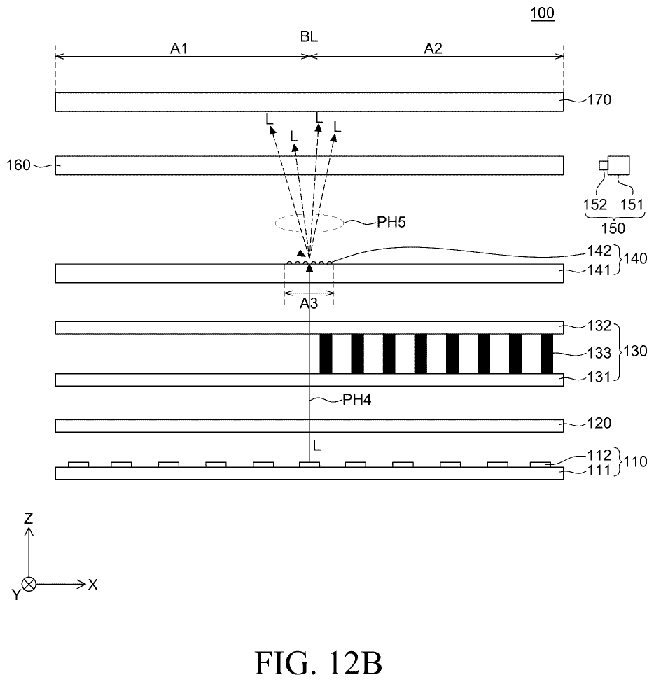

FIGS. 12A and 12B are views for explaining an example of a traveling path of light in a display device according to an example embodiment of the present disclosure.

In the meantime, FIG. 12A illustrates a path of light L which is provided from the second light source unit 150 to describe a configuration which scatters and/or totally reflects light L which is provided from the second light source unit 150 and is refracted in the light guide plate 160 to travel toward the first light controller 130, for example, downwardly, by the second light controller 140.

Further, FIG. 12B illustrates a path of light L which is provided from the first light source unit 110 to describe a configuration which scatters and/or totally reflects light L which is provided from the first light source unit 110 to travel toward the first light controller 130, for example, upwardly, by the second light controller 140.

In the meantime, for the convenience of description, in FIGS. 12A and 12B, a display device 100 including a first light controller 130 according to the example embodiment which has been described with reference to FIGS. 4A and 4B, among various example embodiments of the first light controllers 130, 230, 330, 430, 530, 630, and 730 which have been described with reference to FIGS. 4A to 10B, is illustrated. However, this is merely illustrative and the display device 100 can include the first light controllers 230, 330, 430, 530, 630, and 730 according to any one example embodiment, among various example embodiments which have been described with reference to FIGS. 5A to 10B.

First, referring to FIG. 12A, a plurality of second light sources 152 included in the second light source unit 150 can emit light. In this case, light L which is emitted from the plurality of second light sources 152 to travel to the opposite direction to the first direction X is provided to the light guide plate 160. Here, the light L which is incident to the light guide plate 160 is totally reflected in the light guide plate 160 like a first path PH1 illustrated in FIG. 12A to travel toward the first area A1 which is an opposite direction to the first direction X. At this time, at least a part of light which is totally reflected in the light guide plate 160 is refracted on the boundary surface of the light guide plate 160 to change the traveling direction to the third direction Z which is directed to the display panel 170 to be provided to the display panel 170. At least another part of the light which is totally reflected in the light guide plate 160 is refracted on the boundary surface of the light guide plate 160 to change the traveling direction to the opposite direction to the third direction Z which is directed to the first light controller 130, like a second path PH2 illustrated in FIG. 12A to travel.

In the meantime, as described above, when light L which is refracted on the boundary surface of the light guide plate 160 to be directed to the first light controller 130 through the second path PH2 is directly incident to the area of the first light controller 130 where the boundary line BL between the first area A1 and the second area A2 is located, the light L is reflected from the first light controller 130 to be provided to the display panel 170. Accordingly, there is a limitation in that the boundary is visible in the displayed image.

For example, as described above, the first light controller 130 includes a plurality of partitions 133 disposed on the second area A2 and the partition 133 is not disposed in the first area A1. Accordingly, depending on whether to place the partition 133, in an image which is displayed by light which is incident to the area of the first light controller 130 where the boundary line BL between the first area A1 and the second area A2 is located and then is reflected from the first light controller 130, the boundary is visible.

In the meantime, when the display device 100 includes the first light controller 230 which has been described with reference to FIGS. 5A and 5B, as described above, the boundary in the displayed image can be visible depending on whether to place the partition 233 in each area. Similarly, when the display device 100 includes the first light controller 330, 430, 530, 630, or 730, according to any one example embodiment, among various example embodiments which have been described with reference to FIGS. 6 to 10B, the boundary in the displayed image can be visible depending on the difference of the size, the shape, or the extending direction of the partition 333, 433, 533, 633, or 733.

With regard to this, the display device 100 according to the example embodiment of the present disclosure includes a second light controller 140 disposed between the light guide plate 160 and the first light controller 130. The second light controller 140 controls a profile of light which travels downwardly, for example, to the opposite direction to the third direction Z, from the light guide plate 160 by the plurality of light control patterns 142 disposed on the third area A3 including the boundary line BL between the first area A1 and the second area A2 to reduce or minimize the above-described boundary visibility.

To be more specific, like the second path PH2 illustrated in FIG. 12A, light L which is refracted in the light guide plate 160 to change the traveling direction to the opposite direction to the third direction Z which is directed to the first light controller 130 to be directed to the area of the first light controller 130 in which the boundary line BL between the first area A1 and the second area A2 is located does not directly reach the first light controller 130, but is incident to the second light controller 140 disposed between the light guide plate 160 and the first light controller 130.

At this time, when the light L travels toward an area of the first light controller 130 where the boundary line BL between the first area A1 and the second area A2 is located, the light L is incident to the second light controller 140, specifically, to the third area A3 of the second light controller 140 where the plurality of light control patterns 142 is disposed. Here, the light L which is incident to the third area A3 is scattered and/or totally reflected by the plurality of light control patterns 142 having a hemispherical shape to change the traveling path of the light L to be directed to the third direction Z, like the third path PH3 illustrated in FIG. 12A, to be provided to the display panel 170. Accordingly, the boundary visibility between the first area A1 and the second area A2 can be reduced or minimized.

Next, referring to FIG. 12B, the plurality of first light sources 112 included in the first light source unit 110 emits light to provide light to the display panel 170. For example, light which is provided from the plurality of first light sources 112 to travel to the third direction Z is diffused or condensed by means of the optical sheet 120 to be provided to the first light controller 130.

At this time, like a fourth path PH4 illustrated in FIG. 12B, when light which is incident to the boundary line BL between the first area A1 and the second area A2 of the first light controller 130 is provided to the display panel 170 as it is, there can be a limitation in that the boundary is visible in the displayed image depending on whether to place the partition 133 in each area.

In the meantime, when the display device 100 includes the first light controller 230 which has been described with reference to FIGS. 5A and 5B, as described above, the boundary in the displayed image can be visible depending on whether to place the partition 233 in each area. Similarly, when the display device 100 includes the first light controller 330, 430, 530, 630, or 730, according to any one example embodiment, among various example embodiments which have been described with reference to FIGS. 6 to 10B, the boundary in the displayed image can be visible depending on the difference of the size, the shape, or the extending direction of the partition 333, 433, 533, 633, or 733.

With regard to this, the display device 100 according to the example embodiment of the present disclosure includes a second light controller 140 disposed on the first light controller 130. The second light controller 140 controls a profile of light provided from the first light controller 130 by the plurality of light control patterns 142 disposed on the third area A3 including a boundary line BL between the first area A1 and the second area A2 to reduce or minimize the above described boundary visibility.

To be more specific, like the fourth path PH4 illustrated in FIG. 12B, light L which is emitted from the first light source unit 110 to be incident to the second light controller 140 via the first light controller 130, for example, an area of the first light controller 130 close to the boundary line BL between the first area A1 and the second area A2 is incident to the third area A3 of the second light controller 140 in which the plurality of light control patterns 142 is disposed. Here, the light L which is incident to the third area A3 is scattered and/or totally reflected by the plurality of light control patterns 142 having a semispherical shape to be provided to the display panel 170. Accordingly, the boundary visibility between the first area A1 and the second area A2 can be reduced or minimized.

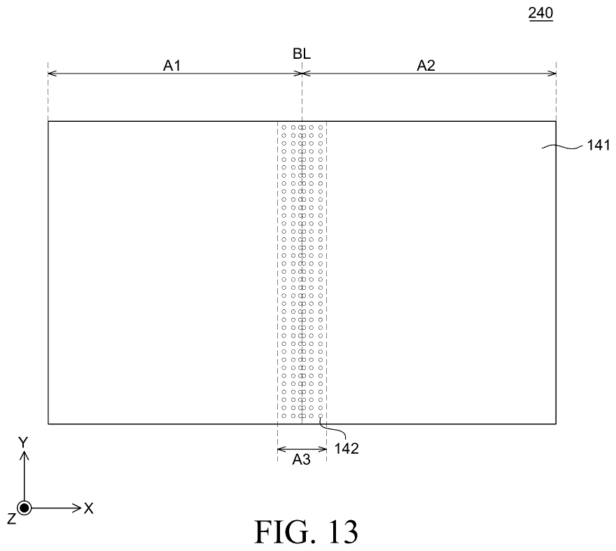

FIG. 13 is a plan view schematically illustrating another example of a second light controller included in the display device of FIG. 2.

In the meantime, the second light controller 240 illustrated in FIG. 13 represents another example of the second light controller 140 included in the display device 100 which has been described with reference to FIG. 2.

Further, FIG. 13 illustrates a modified example of the example embodiment of FIG. 11 with regard to a placement density of a plurality of light control patterns 242 included in the second light controller 240. Accordingly, in FIG. 13, in order to avoid a redundant description, differences from the above-described example embodiments will be mainly described.

Referring to FIG. 13, the second light controller 240 includes a base layer 141 and a plurality of light control patterns 242 disposed on the base layer 141 to scatter and/or totally reflect light incident to the third area A3 in which the plurality of light control patterns 242 is disposed.

The plurality of light control patterns 242 is disposed on the third area A3 to be spaced apart from each other with a different density in each area. For example, the plurality of light control patterns 242 is disposed along the second direction Y with the same or substantially same interval, but is disposed along the first direction X with different intervals. For example, the farther from the boundary line BL between the first area A1 and the second area A2, for example, the farther from the boundary line BL to the first direction X and/or the opposite direction to the first direction X, the smaller the placement density of the light control patterns 242.

In the meantime, the boundary visibility due to the difference of whether to place the partition in each area, the difference in shapes, the difference in sizes, and/or the difference in extending direction can be most severe in the boundary line BL between the first area A1 and the second area A2.

With regard to this, referring to FIG. 13, the more adjacent to the boundary line BL, the higher the placement density of the plurality of light control patterns 242 of the second light controller 240 so that the boundary visibility between the first area A1 and the second area A2 can be more effectively improved.

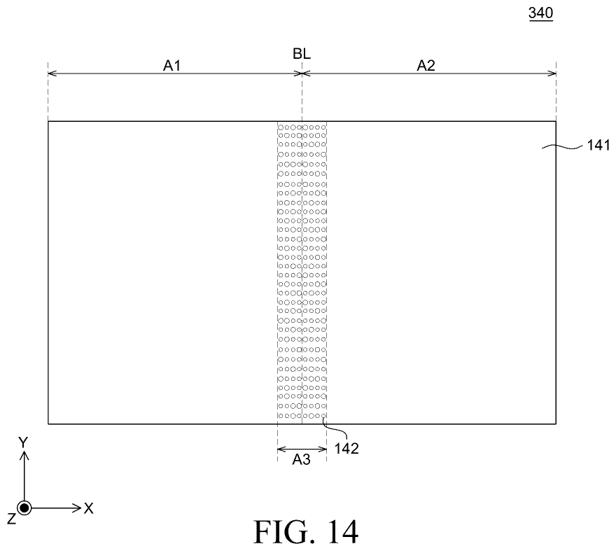

FIG. 14 is a plan view schematically illustrating still another example of a second light controller included in the display device of FIG. 2.

In the meantime, a second light controller 340 illustrated in FIG. 14 represents still another example of the second light controller 140 included in the display device 100 which has been described with reference to FIG. 2.

Further, FIG. 14 illustrates a modified example of the example embodiment of FIG. 11 with regard to a size of a plurality of light control patterns 342 included in the second light controller 340. Accordingly, in FIG. 14, in order to avoid a redundant description, differences from the above-described example embodiments will be mainly described.

Referring to FIG. 14, the second light controller 340 includes a base layer 141 and a plurality of light control patterns 342 disposed on the base layer 141 to scatter and/or totally reflect light incident to the third area A3 in which the plurality of light control patterns 342 is disposed.

The plurality of light control patterns 342 is disposed on the third area A3 to be spaced apart from each other with constant density and interval. Further, each of the plurality of light control patterns 342 has a hemispherical shape.

The plurality of light control patterns 342 has various sizes. For example, the plurality of light control patterns 342 having a hemispherical shape can have various radii. For example, any one of the plurality of light control patterns 342 has a first size and the other one of the plurality of light control patterns 342 has a second size which is different from the first size.

As described above, the plurality of light control patterns 342 does not have the same or substantially same size, but has various sizes so that light which is incident to the third area A3 in which the plurality of light control patterns 342 is disposed can be more effectively scattered. Accordingly, the boundary visibility between the first area A1 and the second area A2 can be more effectively improved.

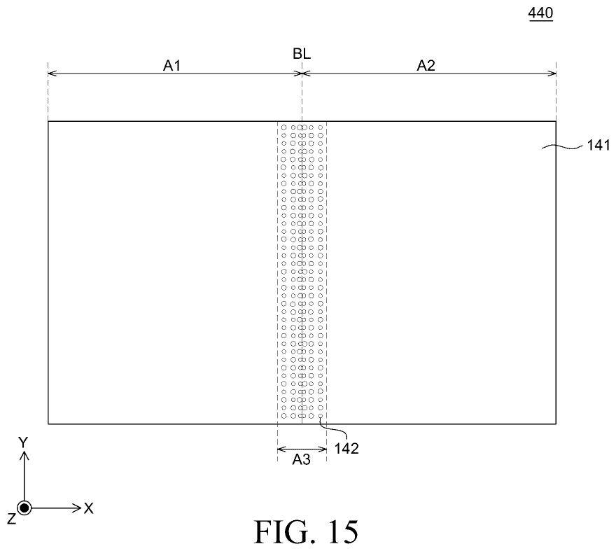

FIG. 15 is a plan view schematically illustrating still another example of a second light controller included in the display device of FIG. 2.

In the meantime, a second light controller 440 illustrated in FIG. 15 represents still another example of the second light controller 140 included in the display device 100 which has been described with reference to FIG. 2.

Further, FIG. 15 illustrates a modified example of the example embodiment of FIG. 13 with regard to a size of a plurality of light control patterns 442 included in the second light controller 440. Accordingly, in FIG. 15, in order to avoid a redundant description, differences from the above-described example embodiments will be mainly described.

Referring to FIG. 15, the second light controller 440 includes a base layer 141 and a plurality of light control patterns 442 disposed on the base layer 141 to scatter and/or totally reflect light incident to the third area A3 in which the plurality of light control patterns 442 is disposed.

The plurality of light control patterns 442 is disposed on the third area A3 to be spaced apart from each other with a different density in each area. For example, the plurality of light control patterns 442 is disposed along the second direction Y with the same or substantially same interval, but is disposed along the first direction X with different intervals. For example, the farther from the boundary line BL between the first area A1 and the second area A2, for example, the farther from the boundary line BL to the first direction X and/or the opposite direction to the first direction X, the smaller the placement density of the light control patterns 442. Accordingly, as described with reference to FIG. 13, the boundary visibility between the first area A1 and the second area A2 can be more effectively improved.

The plurality of light control patterns 442 has various sizes. For example, the plurality of light control patterns 442 having a hemispherical shape can have various radii. For example, any one of the plurality of light control patterns 442 has a first size and the other one of the plurality of light control patterns 442 has a second size which is different from the first size. As described with reference to FIG. 14, the plurality of light control patterns 442 does not have the same size, but has various sizes so that light which is incident to the third area A3 in which the plurality of light control patterns 442 is disposed can be more effectively scattered. Accordingly, the boundary visibility between the first area A1 and the second area A2 can be more effectively improved.

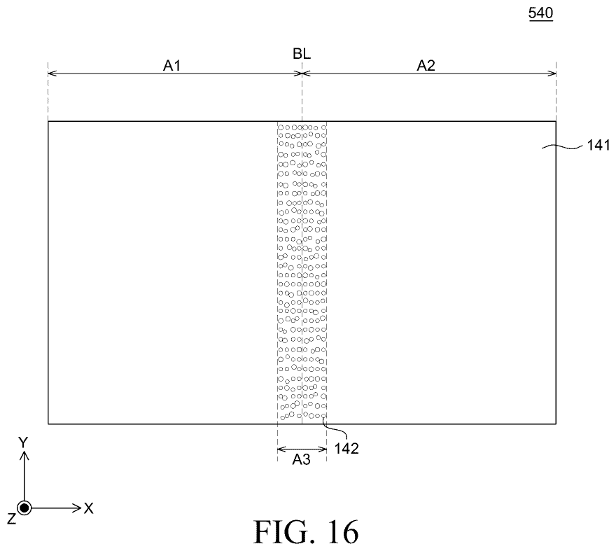

FIG. 16 is a plan view schematically illustrating still another example of a second light controller included in the display device of FIG. 2.

In the meantime, a second light controller 540 illustrated in FIG. 16 represents still another example of the second light controller 140 included in the display device 100 which has been described with reference to FIG. 2.

Further, FIG. 16 illustrates a modified example of the example embodiment of FIG. 11 with regard to a size and a placement density of a plurality of light control patterns 542 included in the second light controller 540. Accordingly, in FIG. 16, in order to avoid a redundant description, differences from the above-described example embodiments will be mainly described.

Referring to FIG. 16, the second light controller 540 includes a base layer 141 and a plurality of light control patterns 542 disposed on the base layer 141 to scatter and/or totally reflect light incident to the third area A3 in which the plurality of light control patterns 542 is disposed.

The plurality of light control patterns 542 is disposed on the third area A3 to be spaced apart from each other with a different density in each area. For example, the plurality of light control patterns 542 is randomly disposed on the third area A3. For example, the plurality of light control patterns 542 can be disposed with different intervals along the first direction X and the second direction Y.

The plurality of light control patterns 542 has various sizes. For example, the plurality of light control patterns 542 having a hemispherical shape can have various radii. For example, any one of the plurality of light control patterns 542 has a first size and the other one of the plurality of light control patterns 542 has a second size which is different from the first size.

As described above, the plurality of light control patterns 542 is not disposed with the constant interval, but is randomly disposed on the third area A3, and all the plurality of light control patterns 542 does not have the same size, but has various sizes. Therefore, light which is incident to the third area A3 in which the plurality of light control patterns 542 is disposed is more effectively scattered. Accordingly, the boundary visibility between the first area A1 and the second area A2 can be more effectively improved.

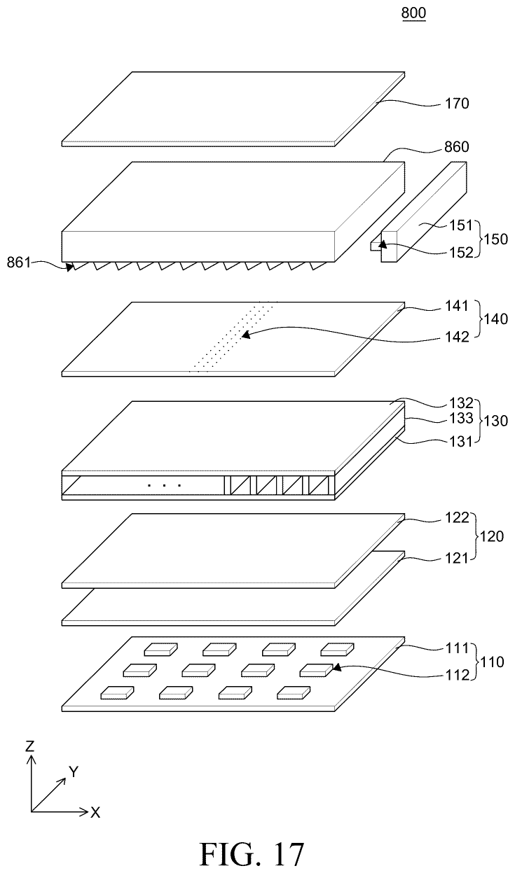

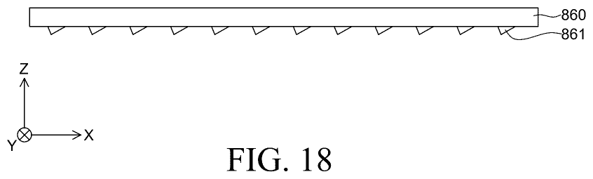

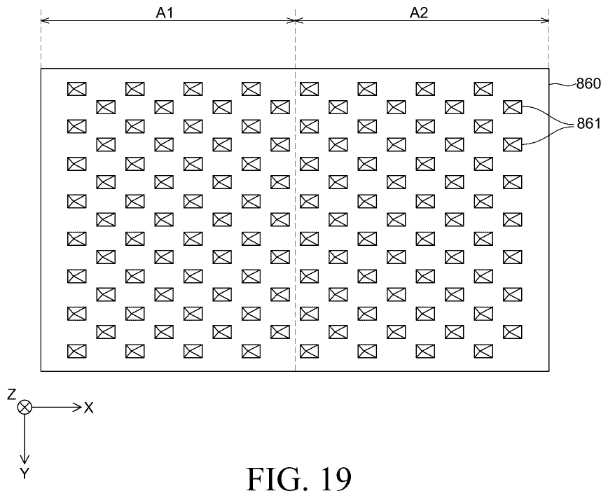

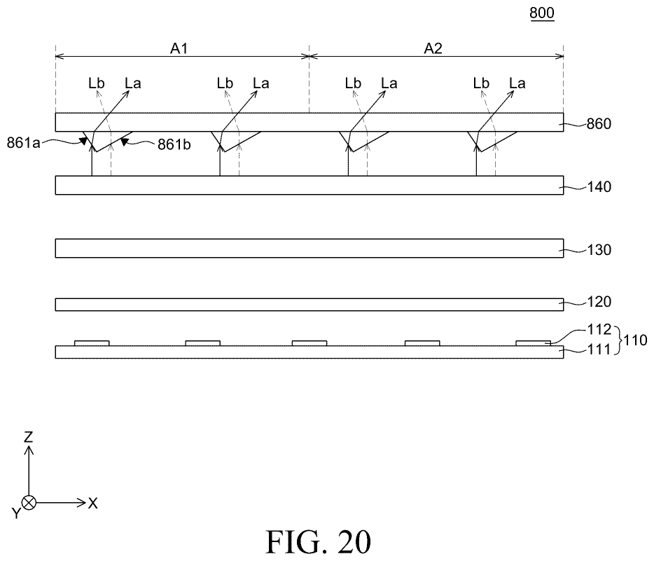

FIG. 17 is an exploded perspective view of a display device according to another example embodiment of the present disclosure. FIG. 18 is a side view schematically illustrating an example of a light guide plate included in the display device of FIG. 17. FIG. 19 is a bottom view schematically illustrating an example of a light guide plate included in the display device of FIG. 17. FIG. 20 is a side view of a display device according to another example embodiment of the present disclosure.

In the meantime, FIG. 17 illustrates a modified example of the example embodiment of FIG. 2 with regard to the light guide plate 860. Accordingly, in FIGS. 17 to 20, in order to avoid a redundant description, differences from the above-described example embodiments will be mainly described.

Referring to FIG. 17, a display device 800 according to another example embodiment of the present disclosure includes a first light source unit 110, at least one optical sheet 120, a first light controller 130, a second light controller 140, a second light source unit 150, a light guide plate 860, and a display panel 170.

The light guide plate 860 is disposed on the second light controller 140 and is disposed on a side portion of the second light source unit 150. The light guide plate 860 guides light provided from the second light source unit 150 to allow the light to travel in a direction toward the display panel 170, for example, in the third direction Z.

The light guide plate 860 includes a plurality of protrusion patterns 861 disposed on a bottom surface. Each of the plurality of protrusion patterns 861 includes a material having a refractive index which is different from that of vacuum or air, for example, a refractive index which is higher than the refractive index of vacuum or air. For example, each of the plurality of protrusion patterns 861 includes the same or substantially same material as the light guide plate 860 so that each of the plurality of protrusion patterns 861 can have the same or substantially same refractive index as the light guide plate 860, but is not limited thereto.

Referring to FIGS. 18 and 19 together, the plurality of protrusion patterns 861 is formed to protrude in a lower direction of the light guide plate 860, for example, in an opposite direction of the third direction Z. Depending on the example embodiment, the plurality of protrusion patterns 861 can be disposed on the bottom surface of the light guide plate 860 with the constant density and interval, but is not limited thereto.

Each of the plurality of protrusion patterns 861 has planes, for example, four inclined surfaces which forms a predetermined angle with a surface defined by the first direction X and the second direction Y. For example, the plurality of protrusion patterns 861 can have a square pyramid shape.

The square pyramid shape of each of the plurality of protrusion patterns 861 can have an asymmetrical shape. For example, square pyramid-shaped vertices included in each of the plurality of protrusion patterns 861 can be formed in an opposite direction to the first direction X, for example, toward the first area A1. Accordingly, as illustrated in FIG. 19, between two inclined surfaces which are included in the square pyramid shape of each of the plurality of protrusion patterns 861 and are opposite to each other along the first direction X, an inclined surface located in the first direction X is formed to be larger than an inclined surface located in an opposite direction to the first direction X.

A profile of light which passes through the light guide plate 860 can be shifted toward the second area A2, for example, toward the first direction X, due to the shape of the protrusion pattern 861. For example, further referring to FIG. 20, the square pyramid shape of each of the plurality of protrusion patterns 861 has an asymmetrical shape. Accordingly, inclination angles of two inclined surfaces 861a and 861b which are included in each of the plurality of protrusion patterns 861 are opposite to each other along the first direction X can be different. For example, between two inclined surfaces 861a and 861b which are opposite to each other along the first direction X, an inclination angle of the first inclined surface 861a which is located in the opposite direction to the first direction X can be larger than an inclination angle of the second inclined surface 861b which is located in the first direction X.

Accordingly, an angle of light La which is incident to the first inclined surface 861a included in each of the plurality of protrusion patterns 861 and is refracted to the first direction X by the protrusion pattern 861 is larger than an angle of light Lb which is incident to the second inclined surface 861b and is refracted to the opposite direction to the first direction X by the protrusion pattern 861. Therefore, the light which is provided from the bottom of the light guide plate 860 can be entirely shifted to the second area A2. Accordingly, in the above-described second mode, the viewing angle of the second area A2 can be more effectively controlled.

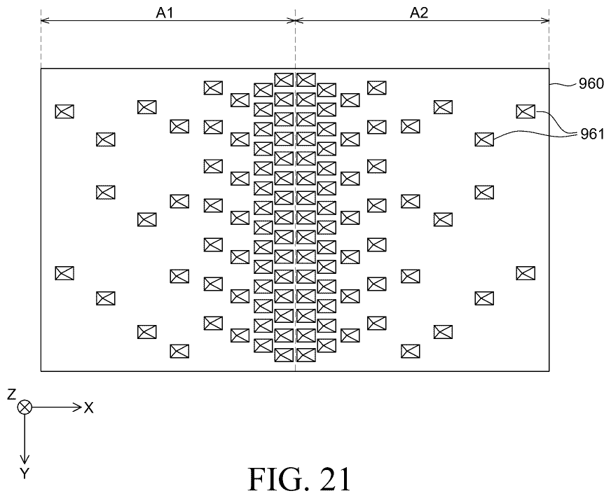

FIG. 21 is a rear-side view schematically illustrating another example of a light guide plate included in the display device of FIG. 17.

In the meantime, FIG. 21 illustrates a modified example of the example embodiment of FIG. 19 with regard to the placement of the protrusion pattern 961. Accordingly, in FIG. 21, in order to avoid a redundant description, differences from the above-described example embodiments will be mainly described.

Referring to FIG. 21, a light guide plate 960 includes a plurality of protrusion patterns 961 which is disposed on a bottom surface and is formed to protrude in a lower direction of the light guide plate 960, for example, in an opposite direction of the third direction Z. The plurality of protrusion patterns 961 is disposed on the bottom surface of the light guide plate 960 with a different density in each area. In the meantime, in the present disclosure, the density with which the protrusion patterns 961 are disposed is defined as a percentage (%) of an area in which the protrusion patterns 961 are disposed with respect to the entire area of the unit area.

For example, the plurality of protrusion patterns 961 is disposed in the first area A1 with a first density and is disposed in the second area A2 with a second density which is larger than the first density. Here, the plurality of protrusion patterns 961 which shifts the light passing through the light guide plate 960 to the first direction X is disposed with a higher density in the second area A2 in which the viewing angle is restricted in the second mode than in the first area A1 depending on the driving mode. Therefore, the viewing angle in the second area A2 can be more effectively controlled.

Further, the plurality of protrusion patterns 961 can be disposed with the third density which is larger than the second density, in the vicinity of the boundary between the first area A1 and the second area A2. Accordingly, the visibility in the vicinity of the boundary between the first area A1 and the second area A2 can be reduced or minimized.

A display device according to the example embodiments of the present disclosure can also be described as follows:

A display device according to an example embodiment of the present disclosure includes a first light source unit including a plurality of first light sources, a first light controller which is disposed on the first light source unit and includes a plurality of partitions overlapping at least a partial area of the active area, a second light controller which is disposed on the first light controller and includes a plurality of light control patterns overlapping at least a partial area of the active area, a second light source unit which is disposed on the second light controller and includes a plurality of second light sources, a light guide plate which is disposed to be parallel to the second light source unit and guides light provided from the second light source unit and a display panel which is disposed on the light guide plate and displays an image using light provided from the first light source unit or the second light source unit.

The active area can include a first area in which an image is displayed at a first viewing angle in each of a first mode and a second mode and a second area which is adjacent to the first area in a first direction and displays an image at the first viewing angle in the first mode and displays an image at a second viewing angle which is smaller than the first viewing angle in the second mode.

The plurality of light control patterns can be disposed to overlap a third area including a boundary line between the first area and the second area.

The plurality of light control patterns can have a hemispherical shape.

The plurality of light control patterns can have the same or substantially same size.

Any one of the plurality of light control patterns can have a first size and the other one of the plurality of light control patterns can have a second size which is different from the first size.

The plurality of light control patterns can be disposed with a constant density on the third area.

The farther from the boundary, the smaller the placement density of the plurality of light control patterns which overlaps the third area.

The plurality of light control patterns can be randomly disposed on the third area.

Each of the plurality of light control patterns can have a refractive index which is larger than a refractive index of air.

The second light controller can further include a base layer which supports the plurality of light control patterns.

Each of the plurality of light control patterns can have the same or substantially same material as the base layer.

The base layer can include a transparent plastic material.

The first mode, all the plurality of first light sources and the plurality of second light sources can emit light and in the second mode, the plurality of first light sources can emits light and the plurality of second light sources can does not emit light.

Although the example embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it can be understood that the above-described example embodiments are illustrative in all aspects and do not limit the present disclosure. The protective scope of the present disclosure can be construed based on the following claims, and all the technical concepts in the equivalent scope thereof can be construed as falling within the scope of the present disclosure.

What is claimed is:

1. A display device, comprising:
a first light source unit including a plurality of first light sources;
a first light controller disposed on the first light source unit and including a plurality of partitions overlapping at least a partial area of an active area;
a second light controller disposed on the first light controller and including a plurality of light control patterns overlapping at least a partial area of the active area;
a second light source unit disposed on the second light controller and including a plurality of second light sources;
a light guide plate disposed to be parallel to the second light source unit and configured to guide light provided from the second light source unit; and
a display panel disposed on the light guide plate and configured to display an image using light provided from the first light source unit or the second light source unit.

2. The display device according to claim 1, wherein the active area includes:
a first area in which an image is displayed at a first viewing angle in each of a first mode and a second mode; and
a second area which is adjacent to the first area in a first direction, the second area configured to display an image at the first viewing angle in the first mode and display an image at a second viewing angle which is smaller than the first viewing angle in the second mode.

3. The display device according to claim 2, wherein the plurality of light control patterns is disposed to overlap a third area including a boundary line between the first area and the second area.

4. The display device according to claim 1, wherein each of at least one of the plurality of light control patterns has a hemispherical shape.

5. The display device according to claim 1, wherein the plurality of light control patterns has a same size.

6. The display device according to claim 1, wherein one of the plurality of light control patterns has a first size and another one of the plurality of light control patterns has a second size which is different from the first size.

7. The display device according to claim 3, wherein the plurality of light control patterns is disposed with a constant density on the third area.

8. The display device according to claim 3, wherein the farther from the boundary line, the smaller a placement density of the plurality of light control patterns which overlaps the third area.

9. The display device according to claim 3, wherein the plurality of light control patterns is randomly disposed on the third area.

10. The display device according to claim 1, wherein each of the plurality of light control patterns has a refractive index which is larger than a refractive index of air.

11. The display device according to claim 1, wherein the second light controller further includes a base layer supporting the plurality of light control patterns.

12. The display device according to claim 11, wherein each of the plurality of light control patterns has a same material as the base layer.

13. The display device according to claim 11, wherein the base layer includes a transparent plastic material.

14. The display device according to claim 2, wherein in the first mode, all the plurality of first light sources and the plurality of second light sources emit are configured to emit light and
in the second mode, the plurality of first light sources is configured to emit light while the plurality of second light sources is configured to not emit light.

15. A display device for displaying an image using light provided from at least one of a first light source unit and a the second light source unit, the display device comprising:
the first light source unit including a plurality of first light sources;
a first light controller disposed on the first light source unit and including a plurality of partitions overlapping at least a partial area of an active area;
a second light controller disposed on the first light controller and including a plurality of light control patterns overlapping at least a partial area of the active area;
the second light source unit disposed on the second light controller and including a plurality of second light sources; and
a light guide plate disposed to be parallel to the second light source unit and configured to guide light provided from the second light source unit.

16. The display device according to claim 15, wherein the active area includes:
a first area in which an image is displayed at a first viewing angle in each of a first mode and a second mode; and
a second area which is adjacent to the first area in a first direction, the second area configured to display an image at the first viewing angle in the first mode and display an image at a second viewing angle which is smaller than the first viewing angle in the second mode.

17. The display device according to claim 16, wherein the plurality of light control patterns is disposed to overlap a third area including a boundary line between the first area and the second area.

18. The display device according to claim 15, wherein each of at least one of the plurality of light control patterns has a hemispherical shape.

19. The display device according to claim 15, wherein each of the plurality of light control patterns has a refractive index which is larger than a refractive index of air.

20. The display device according to claim 15, wherein the second light controller further includes a base layer supporting the plurality of light control patterns.
